(19) United States
(12) Patent Application Publication
(10) Pub. No.: US 2022/0011265 A1
(43) Pub. Date: Jan. 13, 2022

(54) ADAPTIVE SYNCHRONOUS AND ASYNCHRONOUS LANE DETECTION SYSTEMS AND METHODS

(71) Applicant: LI-COR, Inc., Lincoln, NE (US)

(72) Inventor: Patrick G. Humphrey, Lincoln, NE (US)

(21) Appl. No.: 17/486,143

(22) Filed: Sep. 27, 2021

Related U.S. Application Data
(63) Continuation-in-part of application No. 16/911,898, filed on Jun. 25, 2020, now Pat. No. 11,133,087.
(60) Provisional application No. 63/151,351, filed on Feb. 19, 2021.
(60) Provisional application No. 62/869,361, filed on Jul. 1, 2019.

(51) Int. Cl. G01N 27/447; G06K 9/32

(52) U.S. Cl. CPC G01N 27/44739; G01N 27/44721; G06K 9/3233

(57) ABSTRACT

Systems and methods for automatically identifying and characterizing one or more lanes in image data for one or more electrophoresed samples. The method includes receiving data representing an image of one or more electrophoresed samples, segmenting the data into one or multiple data segments or portions within a region of interest (ROI), wherein the one or multiple data segments represent (e.g., when visually displayed) one or multiple lane segments along a first axis in the ROI, each of the one or multiple lane segments traversing one or multiple lanes in the image data, generating an intensity profile for at least a first data segment of the one or multiple data segments along a second axis orthogonal to the first axis, and processing the intensity profile to determine a location and parameters for each of one or multiple lanes in the first data segment.

### CROSS-REFERENCE TO RELATED APPLICATION

This application is a continuation-in-part of, and claims the benefit of priority to U.S. patent application Ser. No. 16/911,898, filed on Jun. 25, 2020, titled “ADAPTIVE LANE DETECTION SYSTEMS AND METHODS,” and which claims priority to U.S. Provisional Patent Application No. 62/869,361, filed Jul. 1, 2019. This application also claims the benefit of priority to U.S. Provisional Patent Application No. 63/151,351, filed Feb. 19, 2021. All of the afore-mentioned applications are hereby incorporated by reference in their entireties.

### BACKGROUND

The present disclosure provides systems and methods for automatically detecting lanes on images of electrophoresed samples.

When analyzing electrophoresed samples on a gel, on a membrane following Western Blot analysis or on a substrate, for example, one of the first steps is to identify the lanes (the number, location and orientation) in an image generated after electrophoresis and/or followed by electrophoresed sample transfer to a membrane or other substrate. Oftentimes the lane widths vary from lane to lane. Also, the width of each individual lane can vary from the top to the bottom of the gel, membrane or substrate. Additionally, the lanes do not always run straight, nor do they always run parallel to each other. Moreover, the lanes are not always evenly spaced nor are the lane signal intensities uniform. These anomalies are the results of the biology, chemistry and physics when electrophoresing samples and vary from gel to gel, membrane to membrane or substrate to substrate as well as within each individual gel, membrane or substrate. This can be problematic when attempting to perform an accurate analysis of the electrophoresed samples or image data thereof. Present manual and automated techniques for analyzing electrophoresis data are tedious, error-prone, and unreliable.

### SUMMARY

The adaptive lane detection systems and methods according to the present embodiments automatically and accurately detect the number of lanes as well as the left and right boundaries of each corresponding individual lane in an image of electrophoresed samples. The embodiments are also able to account for variable lane widths, non-uniform signal intensities, and varying degrees of lane curvature. The embodiments advantageously solve the challenging problem of detecting and extracting the lane boundary characteristics on an image of electrophoresed samples where the lane characteristics may be inconsistent and are often located on a non-uniform background which can contain other gel, membrane or substrate artifacts.

According to an embodiment, a computer-implemented method of automatically identifying and characterizing one or more lanes in image data for one or more electrophoresed samples is provided. The method includes receiving data representing an image of one or more electrophoresed samples, segmenting the data into one or multiple data segments or portions within a region of interest (ROI), wherein the one or multiple data segments represent (e.g., when visually displayed) one or multiple lane segments along a first axis in the ROI, each of the one or multiple lane segments traversing one or multiple lanes of the one or more lanes in the image data, generating an intensity profile for at least a first data segment of the one or multiple data segments along a second axis orthogonal to the first axis (e.g., by summing up intensity values along the second axis for each first axis location), processing the intensity profile to determine a location and parameters for each of one or multiple lanes in the first data segment, and outputting the determined locations and parameters of the one or multiple lanes in the first data segment. It should be understood that a “data segment” may also be referred to herein as a “ROI segment”.

In certain aspects, the method further includes rendering an image of the one or multiple lanes in the first data segment in the ROI, and/or an outline of the one or multiple lanes in the first data segment in the ROI based on the determined locations and parameters of the one or multiple lanes in the first data segment. In certain aspects, generating the intensity profile includes summing up intensity values in the first data segment along the second axis for each of a plurality of first axis locations.

According to an embodiment, a computer-implemented method of automatically identifying and characterizing one or more lanes in image data for one or more electrophoresed samples is provided. The method includes receiving data representing an image of one or more lanes of electrophoresed samples, segmenting the data into one or multiple data segments within a region of interest (ROI), wherein the one or multiple data segments represent one or multiple lane segments along a first axis in the ROI, each of the one or multiple lane segments traversing multiple lanes of the one or more lanes in the image data, generating an intensity profile for at least a first data segment of the one or multiple data segments along a second axis orthogonal to the first axis in the ROI, processing the intensity profile to determine a location and parameters for each of one or multiple lanes in the first data segment, and outputting the determined locations and parameters of the one or multiple lanes in the first data segment.

In certain aspects, the method further includes, for each of the one or multiple lanes in the one or multiple data segments, rendering an image of the one or multiple lanes and/or an outline of the one or multiple lanes in the one or multiple data segments based on the determined locations and parameters of the one or multiple lanes in the one or multiple data segments. In certain aspects, the method further includes, for each of the one or multiple lanes, combining together the corresponding locations and parameters determined for each of the one or multiple data segments.

According to certain aspects, the parameters may include an approximate lane width value, and the processing includes determining the approximate lane width value for the one or multiple lanes. In certain aspects, determining the approximate lane width value includes: calculating a derivative of the intensity profile across the first axis to produce a differential curve, the differential curve including positive and negative differential curve pairs; iteratively producing an array of shifted differential curves by: incrementally shifting the positive and negative differential curve pairs relative to each other by incremental amounts defined by a minimum and a maximum lane width shift parameter value; and combining the positive and negative differential curve pairs together for each lane width shift parameter value to produce a shifted differential curve; for each of the shifted differential curves in the array: squaring or taking the absolute value and combining the differential curve, and determining a lane width fit error; and determining a minimum lane width fit error, wherein the lane width shift parameter value corresponding to the minimum lane width fit error is determined as the approximate lane width value.

In certain aspects, a method may further include detecting the one or multiple lanes in the one or multiple data segments based on the determined approximate lane width value.

In certain aspects, detecting the one or multiple lanes in a data segment includes: determining a minimum lane width value, a maximum lane width value and an increment value based on the approximate lane width value; and detecting an optimal lane width and locations for each of the one or more lanes using an iterative lane width and location determination algorithm, wherein for each incremental value starting with the maximum or minimum lane width value, a model profile is determined and compared with the intensity profile in the one or multiple data segments.

According to an embodiment, a system is provided that is configured to automatically identify and characterize one or more lanes in image data for one or more electrophoresed samples, the system comprising one or more processors, and a memory storing instructions, which when executed by the one or more processors, cause the one or more processors to receive or acquire data representing an image of one or more lanes of electrophoresed samples, segment the image into one or multiple data segments within a region of interest (ROI), along a first axis in the ROI, each of the one or multiple data segments traversing one or multiple lanes of the one or more lanes, generate an intensity profile for at least a first data segment of the one or multiple data segments along a second axis orthogonal to the first axis in the ROI, process the intensity profile to determine a location and parameters for each of the one or multiple lanes in the first data segment, and output the determined locations and parameters of the one or multiple lanes in the first data segment.

According to a further embodiment, a system is provided that is configured to automatically identify and characterize one or more lanes in image data for one or more electrophoresed samples, the system comprising one or more processors, and a memory storing instructions, which when executed by the one or more processors, cause the one or more processors to receive data representing an image of one or more electrophoresed samples, segment the image data into one or multiple data segments within a region of interest (ROI) along a first axis in the ROI, each of the one or multiple data segments traversing one or multiple lanes, generate an intensity profile for each of the one or multiple data segments along a second axis orthogonal to the first axis in the ROI, process each intensity profile to determine a location and parameters for each corresponding segment of the one or multiple data segments, and output the determined locations and parameters of the one or multiple lanes for each of the one or multiple data segments.

According to yet another embodiment, a computer-implemented method is provided for automatically identifying and characterizing one or more lanes in image data for one or more electrophoresed samples, the method including receiving image data representing an image of one or more lanes of electrophoresed samples, segmenting the image into one or multiple data segments within a region of interest (ROI) in the image, along a first axis in the ROI, each of the one or multiple data segments traversing one or multiple lanes of the one or more lanes, generating an intensity profile for each of the one or multiple data segments along a second axis orthogonal to the first axis in the ROI, determining an approximate lane width value for the one or multiple lanes, processing, in a synchronous manner, the intensity profile and the approximate lane width value to determine lane characteristics for each of the one or multiple lanes represented in each of the one or multiple data segments, wherein the lane characteristics include a number of the one or multiple lanes, a location of each lane along the second axis, and a left edge and a right edge of each lane along the second axis, and outputting at least some of the lane characteristics of the one or multiple lanes represented in the one or multiple data segments.

In certain aspects, the processing, in a synchronous manner, the intensity profile and the approximate lane width value to determine lane characteristics for each of the one or multiple lanes represented in the first data segment includes calculating minimum and maximum values for each lane width and gap width for the one or multiple lanes represented in each of the one or multiple data segments, calculating average intensity values for each lane and each gap, calculating a lane-to-gap ratio and delta values based on the average lane intensity values and average gap intensity values, and synthesizing a set of intensity profiles for the one or multiple data segments that maximize a summation of the segment lane-to-gap values and/or delta values without exceeding limits on differences that can occur between consecutive lane width and gap width values.

In certain aspects, the determining the approximate lane width value includes calculating a derivative of the intensity profile across the second axis to produce a differential curve, the differential curve including positive and negative differential curve pairs, iteratively producing an array of shifted differential curves by: incrementally shifting the positive and negative differential curve pairs relative to each other by incremental amounts defined by a minimum and a maximum lane width shift parameter value; and combining the positive and negative differential curve pairs together for each lane width shift parameter value to produce a shifted differential curve, for each of the shifted differential curves in the array: squaring or taking the absolute value and combining the differential curve, and determining a lane width fit error, and determining a minimum lane width fit error, wherein the lane width shift parameter value corresponding to the minimum lane width fit error is determined as the approximate lane width value.

According to an embodiment, a system is provided that is configured to automatically identify and characterize one or more lanes in image data for one or more electrophoresed samples, the system including one or more processors, and a memory storing instructions. The instructions, when executed by the one or more processors, cause the one or more processors to receive image data representing an image of one or more lanes of electrophoresed samples, segment the image into one or multiple data segments within a region of interest (ROI) in the image, along a first axis in the ROI, each of the one or multiple data segments traversing one or multiple lanes of the one or more lanes, generate an intensity profile for each of the one or multiple data segments along a second axis orthogonal to the first axis in the ROI, determine an approximate lane width value for the one or multiple lanes, process, in a synchronous manner, the intensity profile and the approximate lane width value to determine lane characteristics for each of the one or multiple lanes represented in each of the one or multiple data segments, wherein the lane characteristics include a number of the one or multiple lanes, a location of each lane along the second axis, and a left edge and a right edge of each lane along the second axis, and output at least some of the lane characteristics of the one or multiple lanes represented in the one or multiple data segments.

According to certain aspects, a method (or system) may further include receiving a selection of the ROI, the ROI including data representing the one or multiple lanes. In certain aspects, the selection of the ROI includes a selection received from a user input device. In certain aspects, the selection of the ROI includes a selection received from, or identified by, an artificial intelligence algorithm.

In a further embodiment, a non-transitory computer readable medium is provided that stores instructions, which when executed by one or more processors, cause the one or more processors to implement a method of automatically identifying and characterizing one or more lanes in image data for one or more electrophoresed samples as described herein.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE SEVERAL VIEWS OF THE DRAWINGS

FIG. 1 is a conceptual diagram illustrating an adaptive lane detection system and general process flow, according to an example embodiment. Note that the lane boundaries have been identified in the output image.

FIG. 2 is a flow diagram for a method for determining the lanes within image data, for a region of interest, according to an example embodiment.

FIG. 3 illustrates an example of image data of electrophoresed samples. Image collected of a membrane following the performance of Western Blot analysis.

FIG. 4 illustrates an example of image data of electrophoresed samples region of interest (ROI).

FIG. 5 illustrates an example of image data of electrophoresed samples region of interest (ROI) segments.

FIG. 6 illustrates an example of image data of electrophoresed samples region of interest (ROI) segment intensity profile.

FIG. 7 shows a flow diagram for a method for determining the approximate lane width for image data of electrophoresed samples in the region of interest (ROI) segments, according to an example embodiment.

FIG. 8 shows a differential curve generated by calculating a differential of image data of electrophoresed samples region of interest (ROI) segment intensity profile, according to an example embodiment.

FIG. 9 illustrates a plot of Lane Width Fit Error vs Lane Width for image data of electrophoresed samples in the region of interest (ROI) segments, according to an example embodiment. Note that the minimum lane width fit error occurs at the approximate lane width value (33).

FIG. 10 is a flow diagram for a method for detecting lanes within an image ROI segment, according to an example embodiment.

FIG. 11 is a flow diagram for a method for determining the optimal lane width and location within an image ROI segment, according to an example embodiment.

FIG. 12 is a flow diagram for a method for determining the optimal lane location for a specified lane width value within an image ROI segment, according to an example embodiment.

FIG. 13 is a conceptual diagram of an image ROI segment intensity profile and model profile for one detected lane, according to an example embodiment.

FIG. 14 is a conceptual diagram of an image ROI segment intensity profile and model profile for two detected lanes, according to an example embodiment.

FIG. 15 is a conceptual diagram of an image ROI segment intensity profile and model profile for three detected lanes, according to an example embodiment.

FIG. 16 is a conceptual diagram of an image ROI segment intensity profile and model profile for four detected lanes, according to an example embodiment.

FIG. 17 is a conceptual diagram of an image ROI segment intensity profile and model profile for five detected lanes, according to an example embodiment.

FIG. 18 is a conceptual diagram of an image ROI segment intensity profile and model profile for six detected lanes, according to an example embodiment.

FIG. 19 is a conceptual diagram of an image ROI segment intensity profile and model profile for seven detected lanes, according to an example embodiment.

FIG. 20 is a conceptual diagram of an image ROI segment intensity profile and model profile for eight detected lanes, according to an example embodiment.

FIG. 21 is a conceptual diagram of an image ROI segment intensity profile and model profile for nine detected lanes, according to an example embodiment.

FIG. 22 is a conceptual diagram illustrating the detected lane results of the method for an example image ROI, according to an example embodiment.

FIG. 23 is a conceptual diagram illustrating the zoomed in detected lane results of the method for an example image ROI, according to an example embodiment.

FIG. 24 is a conceptual diagram illustrating the zoomed in detected lane results of the method for an example image ROI, according to an example embodiment.

FIG. 25 is a block diagram of example functional components for a computing system or device configured to perform one or more of the analysis techniques described herein, according to an embodiment.

FIG. 26 is a conceptual diagram illustrating an adaptive synchronous lane detection system and general process flow, according to an example embodiment. Note that the lane boundaries have been precisely identified.

FIG. 27 is a flow diagram for a method for determining the lanes within image data for a region of interest by synchronous detection and synthesis, according to an embodiment.

FIG. 28 illustrates an example of image data of electrophoresed samples. Image collected of a membrane following the performance of Western Blot analysis.

FIG. 29 illustrates an example of image data of electrophoresed samples region of interest (ROI).

FIG. 30 illustrates an example of image data of electrophoresed samples region of interest (ROI) segments.

FIG. 31 illustrates an example intensity profile of image data of electrophoresed samples in a region of interest (ROI) segment #4.

FIG. 32 shows a flow diagram for a method for performing synchronous lane detection and synthesis for a set of segment intensity profiles, according to an example embodiment.

FIG. 33 illustrates an example of image data of electrophoresed samples in the region of interest (ROI) segment #4 intensity profile with lane and gap boundaries, according to an example embodiment.

FIG. 34. illustrates an example of image data of electrophoresed samples in the region of interest (ROI) segment #4 intensity profile with lane and gap boundaries and calculated lane and gap average intensity detection profile for a lane width of 36, gap width of 6, and lane shift value of 0, according to an example embodiment.

FIG. 35 illustrates an example of image data of electrophoresed samples in the region of interest (ROI) segment #4 intensity profile with calculated lane and gap average intensity detection profile for a lane width of 36, gap width of 6, and lane shift value of 0, according to an example embodiment.

FIG. 36 illustrates an example of image data of electrophoresed samples in the region of interest (ROI) segment #4 intensity profile with calculated lane and gap average intensity detection profile for a lane width of 36, gap width of 6, and lane shift value of 5, according to an example embodiment.

FIG. 37 illustrates an example of image data of electrophoresed samples in the region of interest (ROI) segment #4 intensity profile with calculated lane and gap average intensity detection profile for a lane width of 36, gap width of 6, and lane shift value of 10, according to an example embodiment.

FIG. 38 illustrates an example of image data of electrophoresed samples in the region of interest (ROI) segment #4 intensity profile with calculated lane and gap average intensity detection profile for a lane width of 36, gap width of 6, and lane shift value of 15, according to an example embodiment.

FIG. 39 illustrates an example of image data of electrophoresed samples in the region of interest (ROI) segment #4 intensity profile with calculated lane and gap average intensity detection profile for a lane width of 36, gap width of 6, and lane shift value of 17, according to an example embodiment.

FIG. 40 illustrates an example of image data of electrophoresed samples in the region of interest (ROI) segment #4 intensity profile with calculated lane and gap average intensity detection profile for a lane width of 36, gap width of 6, and lane shift value of 18, according to an example embodiment.

FIG. 41 illustrates an example of image data of electrophoresed samples in the region of interest (ROI) segment #4 intensity profile with calculated lane and gap average intensity detection profile for a lane width of 36, gap width of 6, and lane shift value of 19, according to an example embodiment.

FIG. 42 illustrates an example of image data of electrophoresed samples in the region of interest (ROI) segment #4 intensity profile with calculated lane and gap average intensity detection profile for a lane width of 36, gap width of 6, and lane shift value of 21, according to an example embodiment.

FIG. 43 illustrates an example of image data of electrophoresed samples in the region of interest (ROI) segment #4 intensity profile with calculated lane and gap average intensity detection profile for a lane width of 36, gap width of 6, and lane shift value of 23, according to an example embodiment.

FIG. 44 illustrates an example of image data of electrophoresed samples in the region of interest (ROI) segment #4 intensity profile with calculated lane and gap average intensity detection profile for a lane width of 36, gap width of 6, and lane shift value of 25, according to an example embodiment.

FIG. 45 illustrates an example of image data of electrophoresed samples in the region of interest (ROI) segment #4 intensity profile with calculated lane and gap average intensity detection profile for a lane width of 36, gap width of 6, and lane shift value of 27, according to an example embodiment.

FIG. 46 illustrates an example of image data of electrophoresed samples in the region of interest (ROI) segment #4 intensity profile with calculated lane and gap average intensity detection profile for a lane width of 36, gap width of 6, and lane shift value of 28, according to an example embodiment.

FIG. 47 illustrates an example of image data of electrophoresed samples in the region of interest (ROI) segment #4 intensity profile with calculated lane and gap average intensity detection profile for a lane width of 36, gap width of 6, and lane shift value of 29, according to an example embodiment.

FIG. 48 illustrates an example of image data of electrophoresed samples in the region of interest (ROI) segment #4 intensity profile with calculated lane and gap average intensity detection profile for a lane width of 36, gap width of 6, and lane shift value of 30, according to an example embodiment.

FIG. 49 illustrates an example of image data of electrophoresed samples in the region of interest (ROI) segment #4 intensity profile with calculated lane and gap average intensity detection profile for a lane width of 36, gap width of 6, and lane shift value of 35, according to an example embodiment.

FIG. 50 illustrates an example of image data of electrophoresed samples in the region of interest (ROI) segment #4 intensity profile with calculated lane and gap average intensity detection profile for a lane width of 36, gap width of 6, and lane shift value of 40, according to an example embodiment.

FIG. 51 is a plot of Lane-to-Gap Intensity Ratio versus Lane Shift for a segment intensity profile using a fixed lane and gap width, according to an example embodiment,

FIG. 52 is plot of Lane-to-Gap Intensity Delta versus Lane Shift for a segment intensity profile using a fixed lane and gap width, according to an example embodiment.

FIG. 53 illustrates example of image data of electrophoresed samples in the region of interest (ROI) segment #1 intensity profile with calculated lane and gap average intensity detection profile for a lane width of 36, gap width of 6, and lane shift value of 24, according to an example embodiment.

FIG. 54 illustrates an example of image data of electrophoresed samples in the region of interest (ROI) segment #2 intensity profile with calculated lane and gap average intensity detection profile for a lane width of 36, gap width of 6, and lane shift value of 24, according to an example embodiment.

FIG. 55 illustrates an example of image data of electrophoresed samples in the region of interest (ROI) segment #3 intensity profile with calculated lane and gap average intensity detection profile for a lane width of 36, gap width of 6, and lane shift value of 22, according to an example embodiment.

FIG. 56 illustrates an example of image data of electrophoresed samples in the region of interest (ROI) segment #4 intensity profile with calculated lane and gap average intensity detection profile for a lane width of 36, gap width of 6, and lane shift value of 23, according to an example embodiment.

FIG. 57 illustrates an example of image data of electrophoresed samples in the region of interest (ROI) segment #5 intensity profile with calculated lane and gap average intensity detection profile for a lane width of 36, gap width of 6, and lane shift value of 23, according to an example embodiment.

FIG. 58 illustrates an example of image data of electrophoresed samples in the region of interest (ROI) segment #6 intensity profile with calculated lane and gap average intensity detection profile for a lane width of 36, gap width of 6, and lane shift value of 22, according to an example embodiment

FIG. 59 illustrates an example of image data of electrophoresed samples in the region of interest (ROI) segment #7 intensity profile with calculated lane and gap average intensity detection profile for a lane width of 37, gap width of 6, and lane shift value of 15, according to an example embodiment.

FIG. 60 is a conceptual diagram illustrating the synchronous lane detection results of the method for an example image data region of interest (ROI), according to an example embodiment.

FIG. 61 is a conceptual diagram illustrating the asynchronous lane detection results of the previous method for an example image data region of interest (ROI), according to an example embodiment.

FIG. 62 is another (second) example of image data of electrophoresed samples. Image collected of a membrane following the performance of Western Blot analysis.

FIG. 63 is an example of a region of interest (ROI) of the second image data of electrophoresed samples.

FIG. 64 is a conceptual diagram illustrating the synchronous lane detection results of the method for the second example image data in the region of interest (ROI), according to an example embodiment.

FIG. 65 is a conceptual diagram illustrating the asynchronous lane detection results of the previous method for the second example image data region of interest (ROI), according to an example embodiment.

FIG. 66 is a third example of image data of electrophoresed samples. Image collected of a membrane following the performance of Western Blot analysis.

FIG. 67 is an example of a region of interest (ROI) of the third image data of electrophoresed samples.

FIG. 68 is a conceptual diagram illustrating the synchronous lane detection results of the method for the third example image data in the region of interest (ROI), according to an example embodiment.

FIG. 69 is a conceptual diagram illustrating the asynchronous lane detection results of the previous method for the third example image data in the region of interest (ROI), according to an example embodiment.

FIG. 70 is a conceptual diagram illustrating the differences between the results of two adaptive lane detection methods for an example image data region of interest (ROI), according to an example embodiment. Note the differences in the identified lane boundaries.

FIG. 71 is a conceptual diagram illustrating the differences between the results of two adaptive lane detection methods for the second example image data region of interest (ROI), according to an example embodiment. Note the differences in the identified lane boundaries.

FIG. 72 is a conceptual diagram illustrating the differences between the results of two adaptive lane detection methods for the third example image data region of interest (ROI), according to an example embodiment. Note the differences in the identified lane boundaries.

### DETAILED DESCRIPTION

Accurate quantitative analysis of image data derived from electrophoresis or Western Blot analysis is dependent upon the accurate characterization of the locations of the lanes. The adaptive lane detection systems and methods of the present embodiments automatically and accurately detect and characterize the number of lanes as well as the left and right boundaries of each corresponding lane in an image of electrophoresed samples. The embodiments are also able to account for variable lane widths, non-uniform signal intensities, and varying degrees of lane curvature. The embodiments advantageously solve the challenging problem of detecting and extracting the lane boundary characteristics on an image of electrophoresed samples where the lane characteristics may be inconsistent and are often located on a non-uniform background which can contain other gel, membrane or substrate artifacts.

In one example, a region of interest (ROI) is specified and includes the desired lanes to be identified and characterized. In an x-y coordinate system, for example, the lanes to be identified may run parallel to the y-axis and orthogonal to the x-axis. The region of interest is then divided along the y-axis into one or multiple sub-regions (or segments) extending along the x-axis. Each segment is then processed to determine a segment intensity profile along the x-axis, location wherein each segment profile represents the cross-section of the intensity of the lanes along the x-axis of the ROI. Each segment profile is then processed by an iterative method to identify the left and right boundaries of each of the lanes within each of the segments in the ROI. The lane boundaries within a segment may be combined with corresponding lane boundaries from other segments to formulate the (entire) lane boundaries in the ROI.

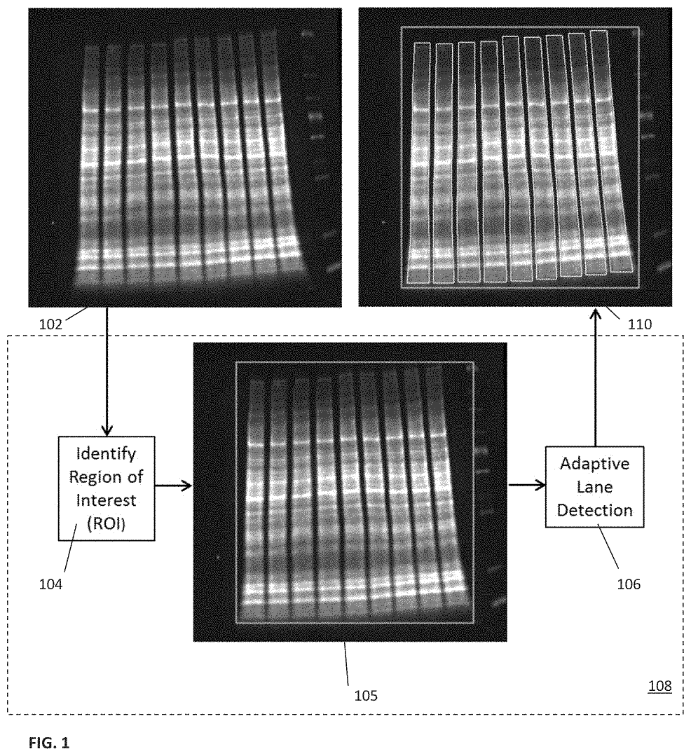

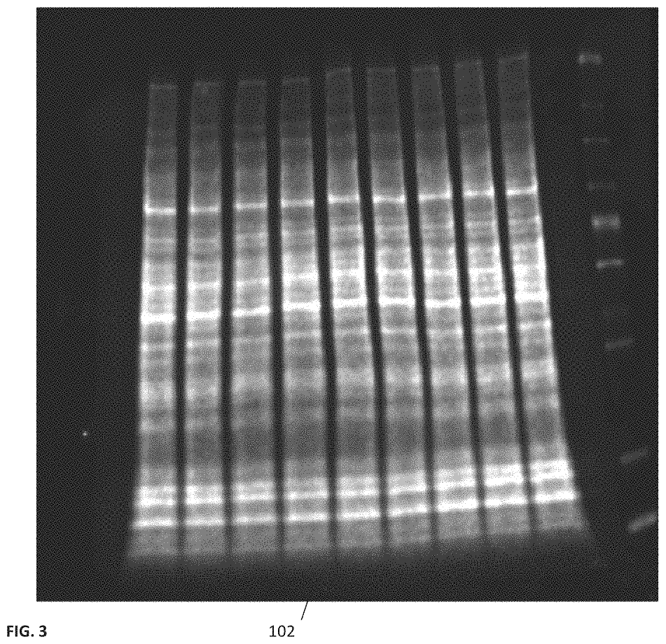

FIG. 1 is a block diagram of an example process flow for determining characteristics or attributes of lanes in electrophoresis data or similar data, according to an embodiment. As shown, electrophoresis image data (hereinafter image data) representing an image 102 is received (see, also FIG. 3). The image data (the “image data” may also be referred to herein as the “image”) may be input or received from any data generating device and typically includes data representing one or more signal lanes. Examples of data generating devices include imaging devices or other devices that generate image data including multiple lanes.

The image 102 is received by lane detection and characterization engine 108. In one example, a region of interest (ROI) is identified at 104. The ROI includes the desired lanes to be identified and characterized. For example, the ROI may include the entire image 102 or a portion of the image 102. As shown in FIG. 1, image 105 illustrates an image wherein the ROI encompasses all lanes visually perceptible from the image 102. In an x-y coordinate system, the lanes to be identified may run parallel to the y-axis and orthogonal to the x-axis. As described in greater detail herein, at 106, lane detection and characterization engine 108 analyzes the image 102 to determine and characterize the constituent lanes present in the ROI of the image 102. Determined information such as the number of constituent lanes present and lane characteristics such as location, left and right boundaries are used to provide an output such as providing data characterizing the constituent lanes and/or rendering an output image 110 which represents a visual representation of the image data signal and its constituent lanes. As shown in FIG. 1, for example, image 102 is determined by the lane detection and characterization engine 108 to have nine (9) constituent lanes, and a display 110 is rendered showing an outline or overlay of the nine constituent lanes including the determined boundaries, which represents the signal content of the image 102. According to various embodiments, the lane detection and characterization engine 108 may be implemented in hardware, software, and/or a combination of hardware and software. Further, lane detection and characterization engine 108 may be implemented in a single processing device or in different processing devices.

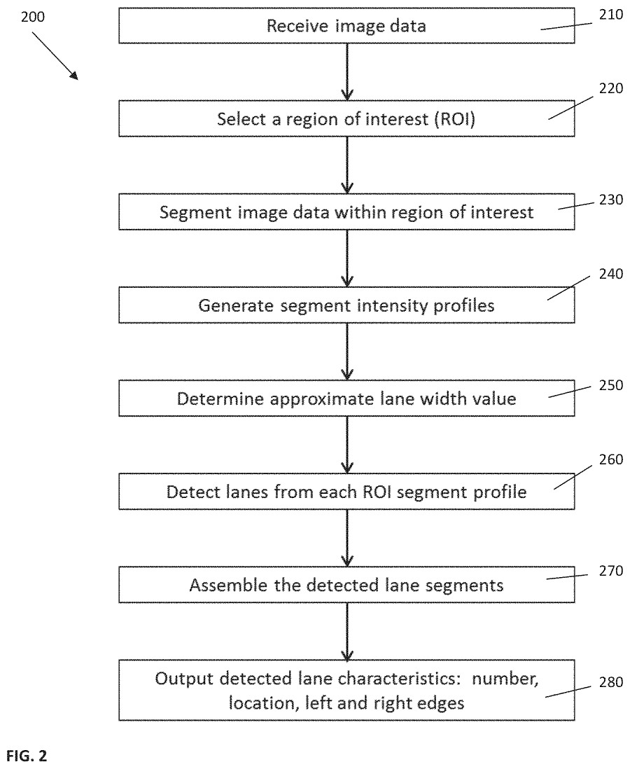

A flow diagram of a method 200 for determining characteristics (e.g., the number, location, orientation, left and right edges) of the lanes present in image data of electrophoresed samples is illustrated in FIG. 2. The method 200 begins at step 210 by lane detection and characterization engine 108 receiving or acquiring an image (e.g., image 102) to be processed. The image data for the image to be processed typically includes intensity values for each pixel of the image. FIG. 3 illustrates an example input electrophoresis image 102.

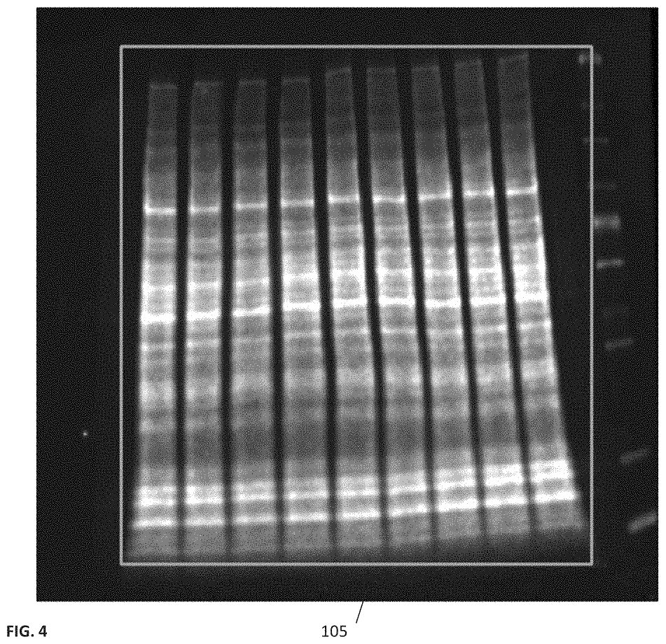

At step 220, a region of interest (ROI) is identified or selected within the image 102. As shown in FIG. 4, the ROI may include substantially the entire image. In another embodiment, the ROI may include a portion of the entire image. In an embodiment, step 220 may include receiving a selection of the ROI from a user input device, e.g., user interface element that outlines or otherwise selects a defined portion of the image. In another embodiment, step 220 may include receiving a selection defined automatically, e.g., defined by an artificial intelligence (AI) algorithm configured to identify a ROI. The AI may include a neural network trained as appropriate for the image data received. An outline of the ROI may be rendered on the image as shown in FIG. 4.

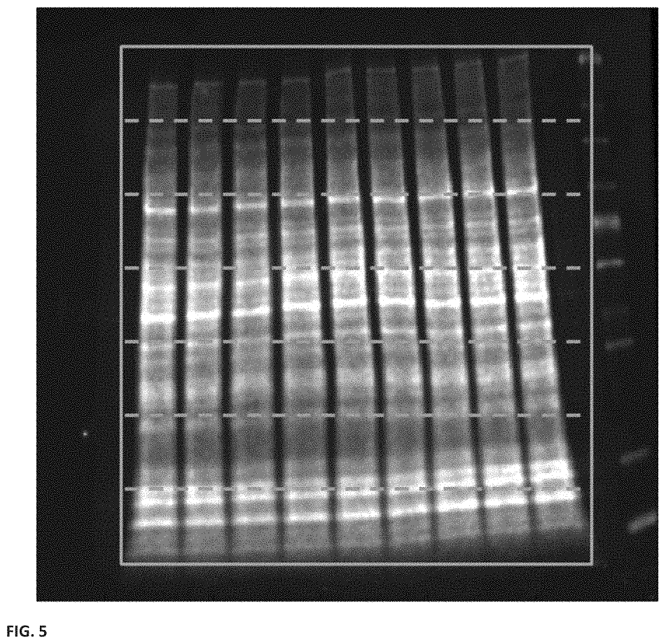

At step 230, the ROI is subdivided along the y-axis into one or multiple image sub-regions or segments. As shown in FIG. 5, an example of the defined ROI of FIG. 4 is subdivided into 7 segments. One skilled in the art will understand that the ROI may be sub-divided into fewer or more segments, e.g., as few as one segment or as many segments as resolution along the y-axis will allow. As illustrated in FIG. 5, in an embodiment, each sub-region or segment spans the entire x-axis. In another embodiment, a segment may span only a portion of the x-axis, e.g., only spanning one or fewer than all lanes in the ROI.

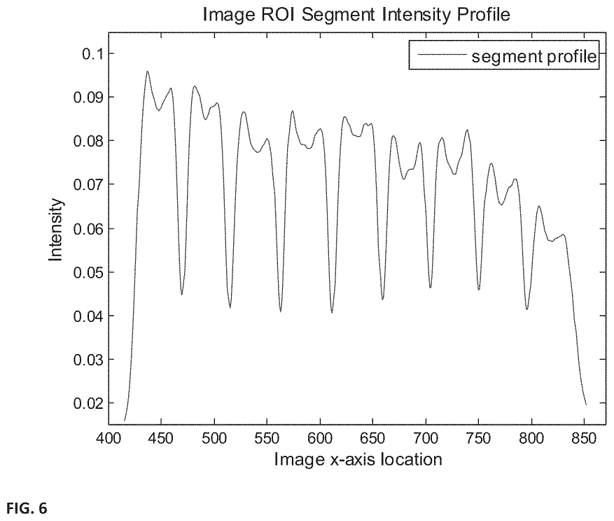

At step 240, segment intensity profiles are generated for each of the subdivided regions/ROI segments, e.g., by summing along the y-axis (at each x-axis location) within each of the segments. Each segment profile represents a cross-section of the lane intensity values along the x-axis for each of the ROI segments. An example segment intensity profile for one ROI segment from FIG. 5 is illustrated in FIG. 6.

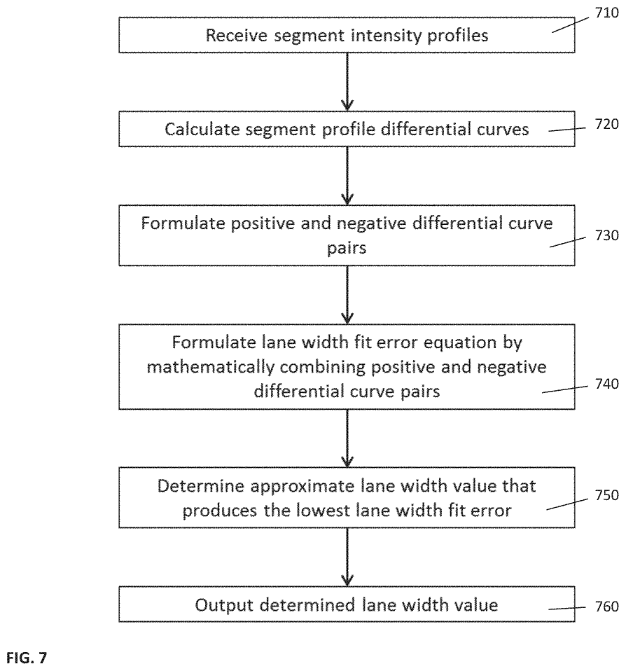

An approximate lane width value for each of the segment profiles is determined at step 250. A flow diagram illustrating an embodiment of a method for determining an approximate lane width value is shown in FIG. 7 (and discussed in more detail below). This is an important step in the characterization of individual lanes. When manually analyzing electrophoresed samples, one of the first things the user may do is formulate a visual approximation of the lane widths and/or widths of bands within the lanes. This enables the user to group the bands into their prospective lanes and to differentiate valid lanes from invalid artifacts. This also enables the lane detection algorithm to be more efficient and robust by targeting the lanes that have valid lane width characteristics.

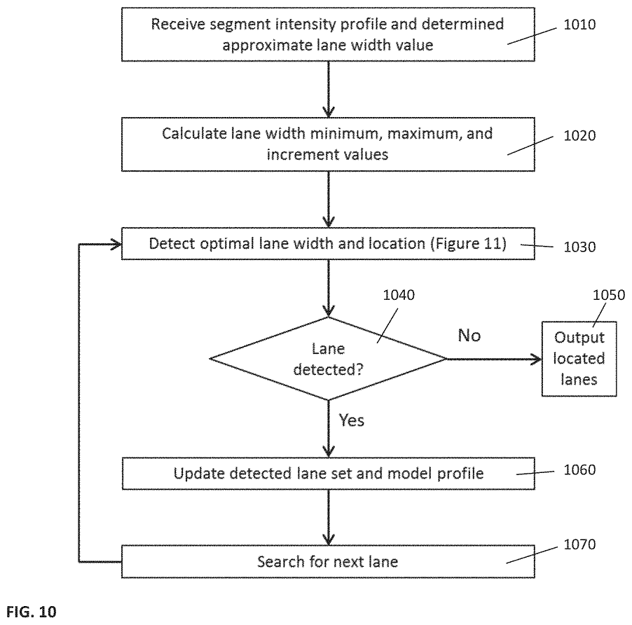

At step 260, the lane(s) from each of the ROI segment intensity profiles being processed are identified or detected using the determined approximate lane width value(s) from step 250. A flow diagram illustrating an embodiment of a method for implementing step 260 will be discussed in more detail below with regard to FIG. 10.

At step 270, identified lane segments from each ROI segment may be assembled together, e.g., to form entire lanes. For example, based on x-axis locations, lanes segments having similar or overlapping locations may be combined to form full lanes in the image.

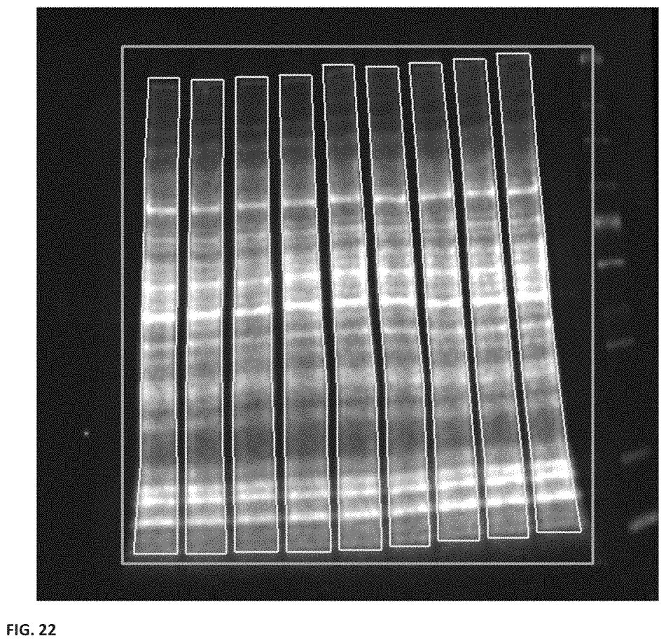

At step 280, the detected lane characteristics or parameters are output. Output lane characteristics may include the number of lanes, the locations of lanes, the left and right edges of lanes, etc., and may be displayed as values, or output or stored for use by another processing algorithm or processing system. In an embodiment, an image of one or more lanes in each data segment and/or an outline of the one or more lanes in each data segment may be rendered based on the determined locations and parameters of the one or more lanes in each data segment. FIG. 22 shows an example of a rendering of the entire received image (e.g., image 102) including an outline of all lanes determined by the lane characterization engine 108.

It should be appreciated that various processing steps as described herein above and below may occur in series/sequentially, simultaneously/in parallel, or individually as would be apparent to one skilled in the art. For example, the determination of features such as the intensity profiles, lanes (location, widths, etc.), and fit error in one ROI segment can occur simultaneously/independent to the determination of the same features in the other ROI segments. As another example, multiple ROI segments may be processed sequentially or in parallel and/or within any segment, multiple lanes may be identified/processed sequentially or in parallel.

As illustrated in FIG. 7, according to an embodiment, an approximate lane width determination method (step 250) is initiated at step 710 by receiving the previously created segment profile(s) from step 240 for each of the ROI segments. At step 720, each of the profiles is converted to a differential curve, e.g., a segment profile differential curve is calculated for each received profile. In an embodiment, step 720 is implemented in accordance with Equation 1 as follows:

$${diff}_{( i , j )} = \frac{n {\sum }_{k = 0}^{n - 1} ( {x}_{( i , j + k )} \cdot {y}_{( i , j + k )} ) - {\sum }_{k = 0}^{n - 1} {x}_{( i , j + k )} \cdot {\sum }_{k = 0}^{n - 1} {y}_{( i , j + k )}}{n ( {\sum }_{k = 0}^{n - 1} {x}_{( i , j + k )}^{2} ) - {( {\sum }_{k = 0}^{n - 1} {x}_{( i , j + k )} )}^{2}} \qquad ( 1 )$$

where
x_{(i,j+k)}=segment profile data point locations,
y_{(i, j+k)}=segment profile data point intensity values,
i=1 to M (M=number of segment profiles),
j=1 to P (P=number of differential segment profile data points),
P=N−n+1,
N=number o f segment profile data points,
n=number of segment profile subsample data points, and
k=segment profile subsample index variable.

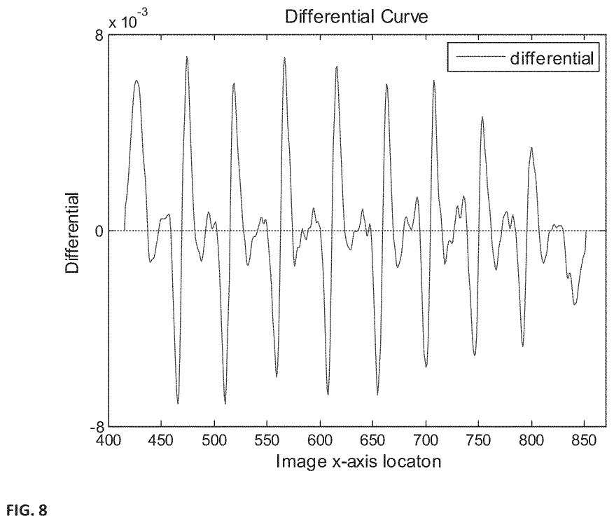

An example of a differential curve generated from Equation 1 is illustrated in FIG. 8. In an embodiment, at step 730, each differential curve is separated into positive and negative differential curve pairs. In an embodiment, a differential curve is separated in accordance with Equations 2 and 3 as follows:

$$\begin{matrix}{posDiff}_{( i , j )} = \{ \begin{matrix}{diff}_{( i , j )} & ( {diff}_{( i , j )} > 0 ) \\ 0 & ( {diff}_{( i , j )} \leq 0 )\end{matrix} & ( 2 ) \\ {negDiff}_{( i , j )} = \{ \begin{matrix}0 & ( {diff}_{( i , j )} \geq 0 ) \\ {diff}_{( i , j )} & ( {diff}_{( i , j )} < 0 )\end{matrix} & ( 3 )\end{matrix}$$

In an embodiment, the positive and negative differential curve pairs are combined at step 740. In an embodiment, the positive and negative differential curve pairs are mathematically combined and a lane width fit error (lwFitErr_{w}) is formulated in accordance with Equation 4 for the determination of the approximate lane width value. Equation 4 is as follows:

$${lwFitErr}_{w} = \{ \begin{matrix}{\sum }_{i = 1}^{M} ( {\sum }_{j = 1 + w}^{P} {( {posDiff}_{( i , j - w )} + {negDiff}_{( i , j )} )}^{2} + \\ {\sum }_{j = P + 1}^{P + w} {( {posDiff}_{( i , j - w )} - {negDiff}_{( i , j - P )} )}^{2} )\end{matrix} \qquad ( 4 )$$

where
w=minimum to maximum lane width value.

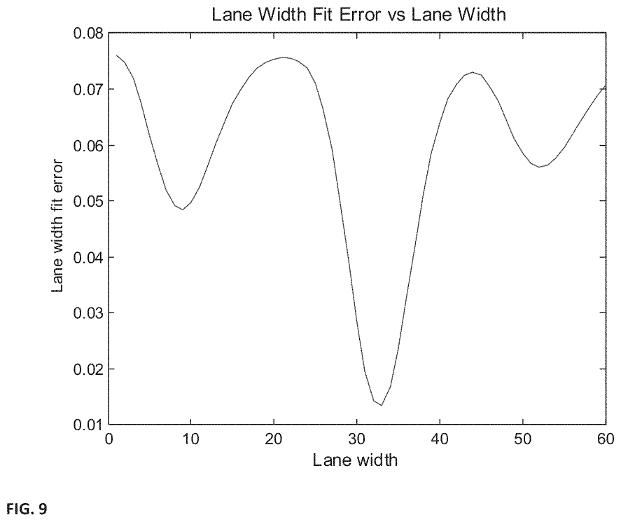

At step 750, an approximate lane width value that produces the lowest lane width fit error is determined. Adding the positive and negative differential curve pairs together results in the original calculated differential curve. In an embodiment, the positive and negative differential curves are incrementally shifted relative to each other and then added together to formulate an array of shifted differential curves. Each of these shifted differential curves may be squared (or the absolute value taken) and summed together, in which the resulting value can be utilized as an indicator of the approximate lane width. In an embodiment, the shift value resulting in the lowest sum of the squares represents the approximate lane width value. Equation 4 is a mathematical representation of an embodiment of the approximate lane width determination method, in which the sum of the squared differentials (or the absolute value) is calculated as a function of shift (lane width) and is illustrated in FIG. 9. It should be noted that the lane width fit error (lwFitErr_{w}) minimum value from Equation 4 occurs at the approximate lane width value, e.g., about 32 or 33 as shown in FIG. 9.

At step 760, the determined approximate lane width value is output. The determined approximate lane width value may be utilized in the detection of the lanes for each ROI segment intensity profile at step 260. A flow diagram of a method for lane detection for each segment profile (step 260) is illustrated in FIG. 10. The method is initiated at step 1010 by receiving the segment intensity profile and the determined approximate lane width value. At step 1020, lane width minimum, maximum and incremental values are calculated. In an embodiment, the minimum, maximum and incremental lane width values may be calculated as a percentage of the pre-determined approximate lane width value.

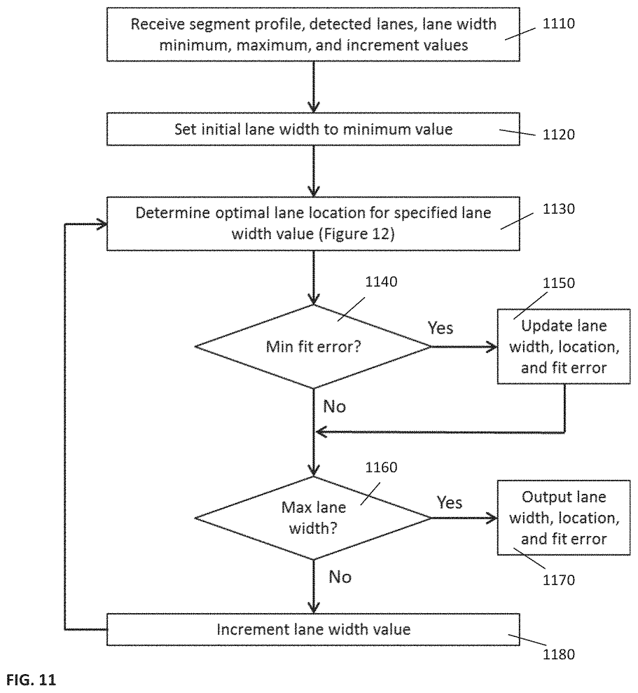

At step 1030, locations and lane width values for each of the lanes in an ROI segment are determined by an iterative optimal lane width and location determination algorithm. An embodiment of a method for detecting an optimal lane width and location (step 1030) is illustrated in the flow diagram of FIG. 11 (discussed in more detail below). At decision step 1040, when a lane is detected, the process moves to step 1060 where the detected lane set and model profile is updated, e.g., data reflecting the detected lanes (lane set) and characteristics stored to a memory. Next, the process proceeds to step 1070 to search for another lane, returning to step 1030. At decision step 1040, when no lane is detected (e.g., indicating all lanes have been found), the process proceeds to step 1050 where the located lanes are output, e.g., data regarding the lanes and characteristics of the lanes is output.

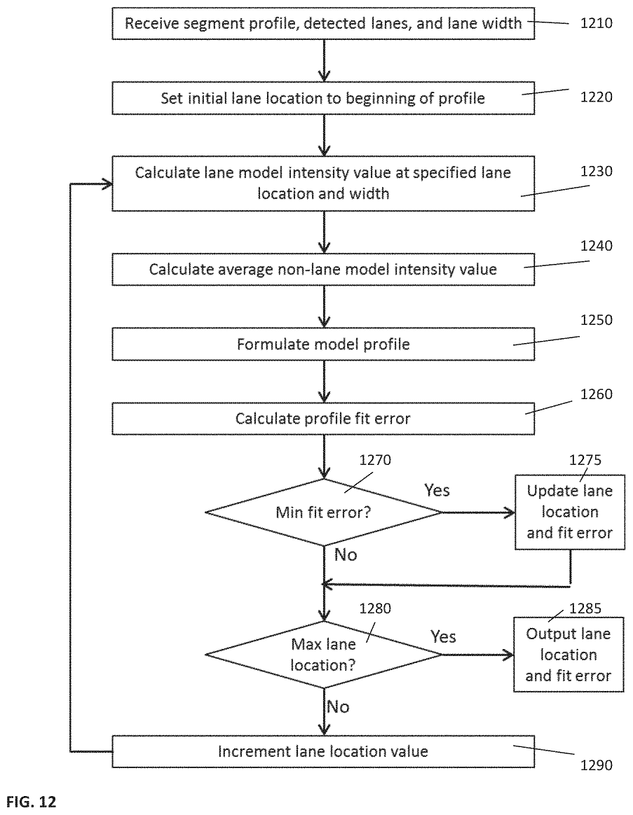

As shown in FIG. 11, a method for detecting an optimal lane width and location begins, at step 1110, where the segment profile, detected lanes and lane width minimum, maximum and incremental values are received. At step 1120, the first lane is found by setting the initial lane width value equal to the minimum value. Then the optimal lane location is determined for the specified lane width value at step 1130. An embodiment of a method for determining an optimal lane location for a specified lane width value (step 1130) is illustrated in the flow diagram FIG. 12 (discussed in more detail below). At decision step 1140, when a minimum fit error is not determined, the process moves to decision step 1160. When a minimum fit error is determined, the lane width, location and fit error is updated (step 1150) and the process proceeds to decision step 1160. At decision step 1160, if the maximum lane width value has been used, the lane width, location and fit error is output at step 1170. At decision step 1160, if the maximum lane width value has not been used, the lane width value is incremented (using the incremental value) at step 1180 and the process returns to step 1130.

As shown in FIG. 12, a method for determining an optimal lane location for a specified lane width value begins, at step 1210, where the segment profile, detected lanes and lane width values are received. At step 1220, the initial lane location is set equal to the beginning of the profile. At step 1230, the lane intensity value for the model profile is calculated, e.g., by averaging the intensity values of the segment intensity profile at the specified lane location and width. At step 1240, non-lane intensity values for the model profile are calculated by averaging the intensity values of the segment intensity profile where there are no located lanes. At step 1250, the model profile is updated with the calculated lane and non-lane intensity values. Next, at step 1260, a profile fit error (profileFitErrᵢ) is calculated. In an embodiment, the profile fit error is calculated in accordance with Equation 5 as follows:

profileFitErrᵢ=Σₘ₌₁^{N}(segProfile_{(i,m)}−modelProfile_{(i,m)})² (5)

where
segProfile_{(i,m)}=segment profile data intensity values,
modelProfile_{(i,m)}=model profile data intensity values,
i=1 to M (M=number of segment profiles), and
m=1 to N (N=number of segment profile data points).

At decision step 1270, when a fit error is not determined to be a minimum fit error, the process moves to decision step 1280. When a fit error is determined to be a minimum fit error, the lane location and fit error is updated (step 1275) and the process proceeds to decision step 1280. At decision step 1280, if the maximum lane location value has been used, the lane location and fit error is output at step 1285. At decision step 1280, if the maximum lane location value has not been used, the lane location value is incremented at step 1290 and the process returns to step 1230.

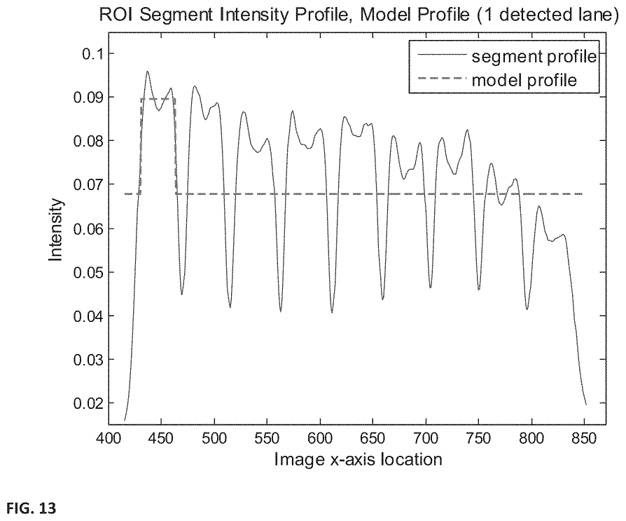

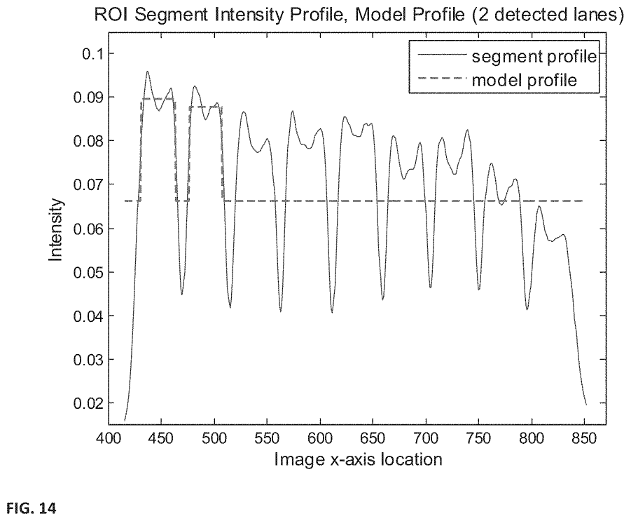

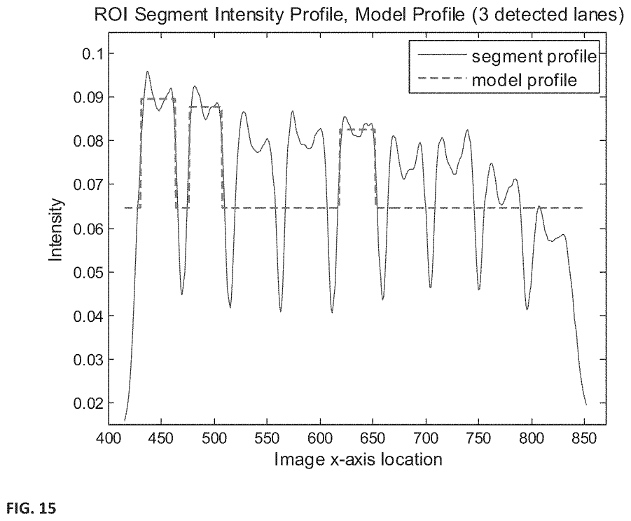

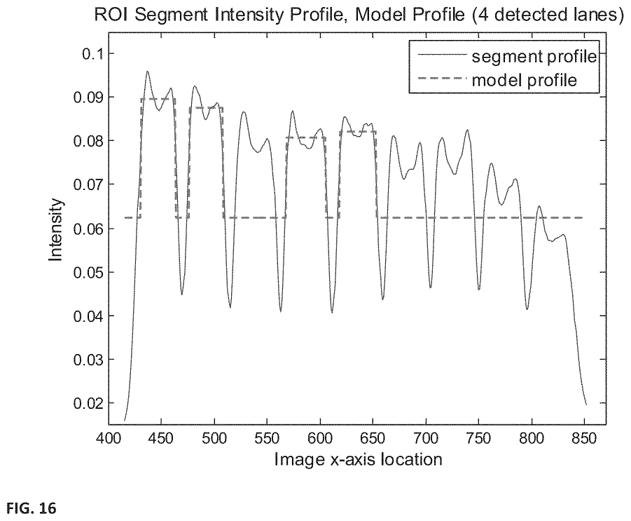

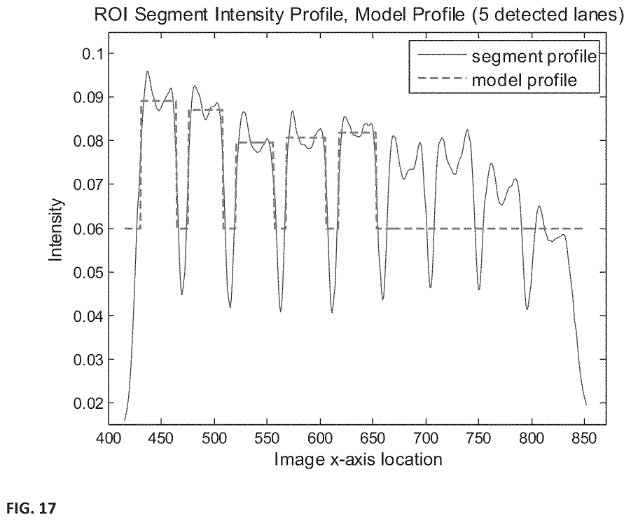

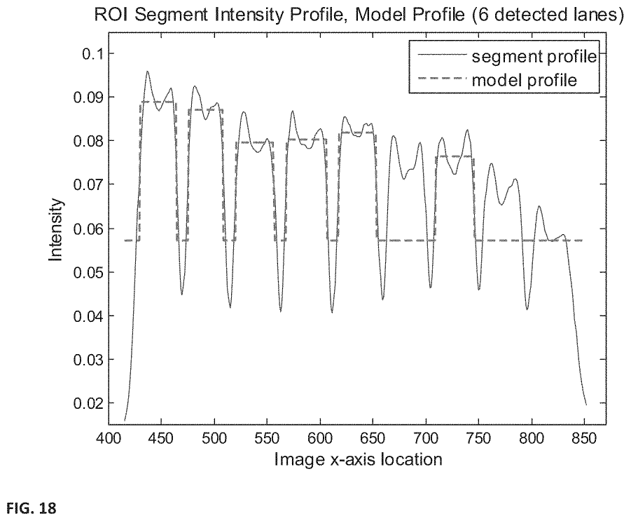

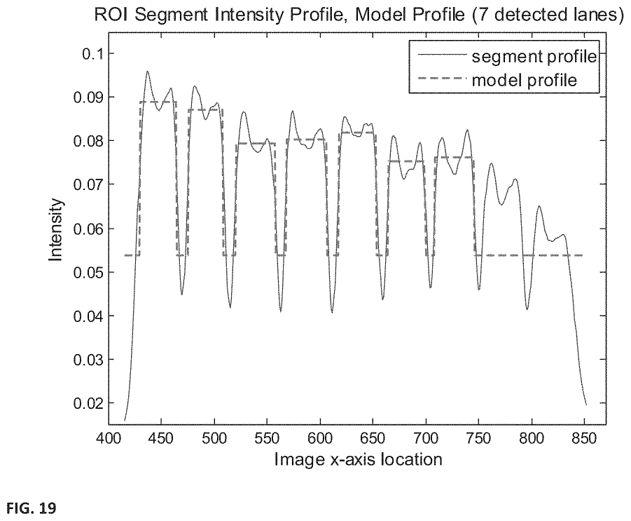

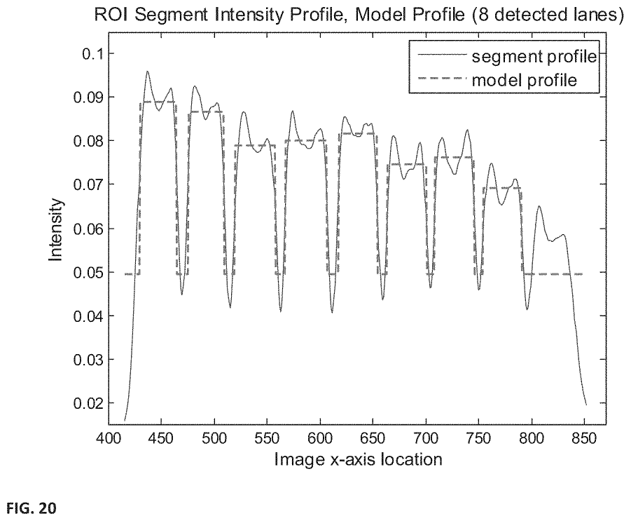

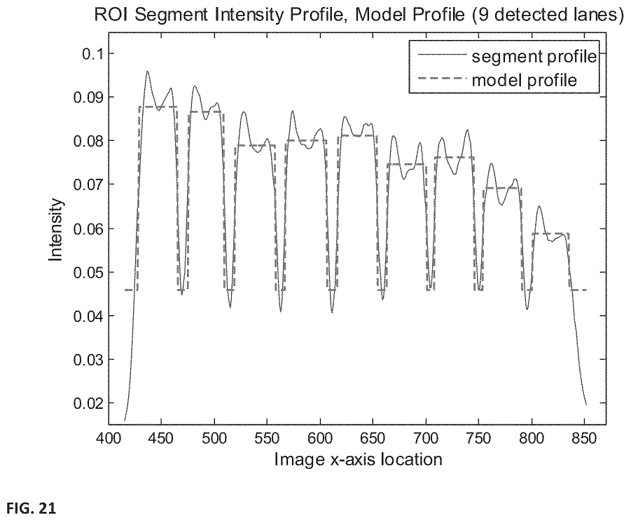

In this manner, the profile fit error is calculated for all possible lane locations and associated lane width increments. The detected lane is the lane location and associated lane width value resulting in the lowest profile fit error. The model of the segment intensity profile for the resultant detected lane is illustrated in FIG. 13. Additional lanes are detected by repeating this iterative process until all lanes are found in the ROI segment. Results of the incrementally updated detected lanes and their associated model profiles are illustrated in FIGS. 14-21.

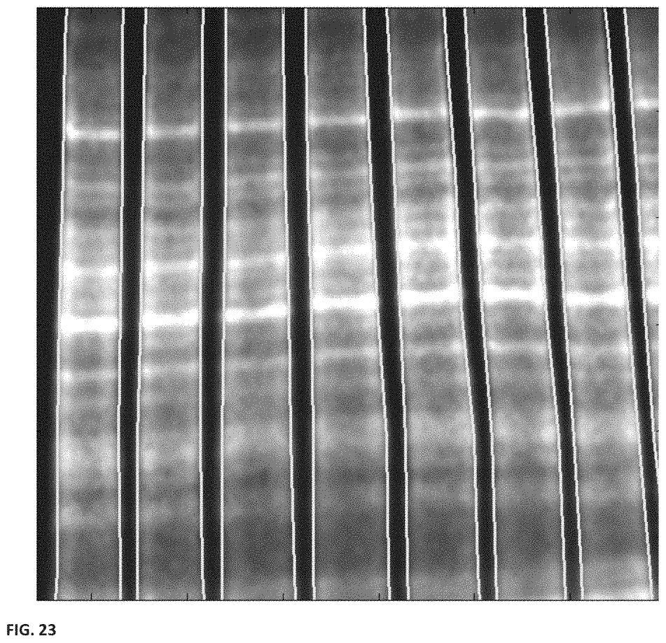

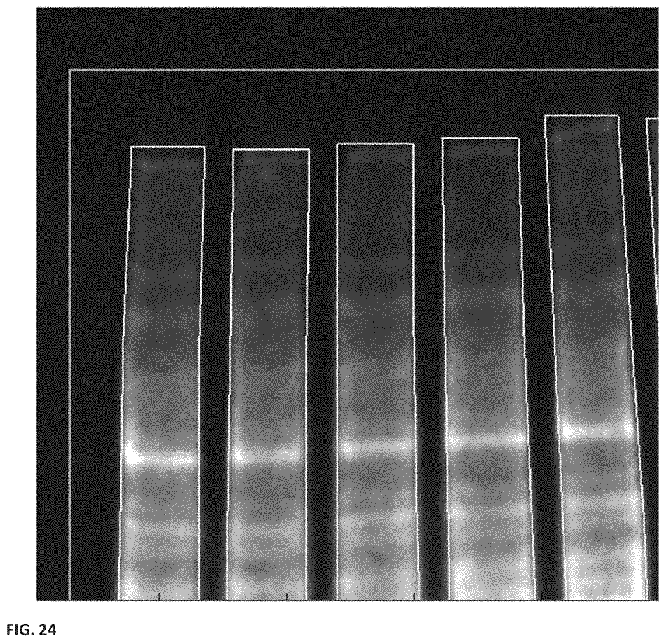

Returning to step 270 of FIG. 2, each of the identified lane locations within each ROI segment may be accurately assembled together to formulate one cohesive set of lanes in the entire ROI. The characterization of each lane across all data/ROI segments will then be complete and can be output or displayed (step 280), e.g., as illustrated in FIGS. 22-24.

### Adaptive Synchronous Lane Detection

The following embodiments build upon the system and method embodiments disclosed above, which provide systems and methods for detecting the lanes (e.g., number, location and orientation) on gel electrophoresis images where the lanes oftentimes have non-uniform widths, intensities and spacings. The following embodiments advantageously perform the lane detection and assembly in a sequential asynchronous manner. This may provide for a more robust and accurate lane detection capability, particularly when the lane signals are sparse, and the intensities are weak. This is accomplished, in certain embodiments, by searching for a set of lanes in a synchronous fashion, rather than searching for the lanes asynchronously.

The ability to more accurately detect lanes on an image where the lane signals are sparse, and the intensities are weak is significant, because this is a common occurrence on images of substrates derived from the performance of electrophoresis, including but not limited to gels, membranes and other like substrates. The present embodiments address the challenging conditions where the lanes have variable widths, spacings and intensities, along with the additional challenges of sparse lane signals with low signal intensities. It is important to perform accurate lane identification and characterization, because identifying the lanes is one of the first steps when analyzing Western Blot data or related images. The present embodiments provide an improvement in the robustness and accuracy in the execution of this first step.

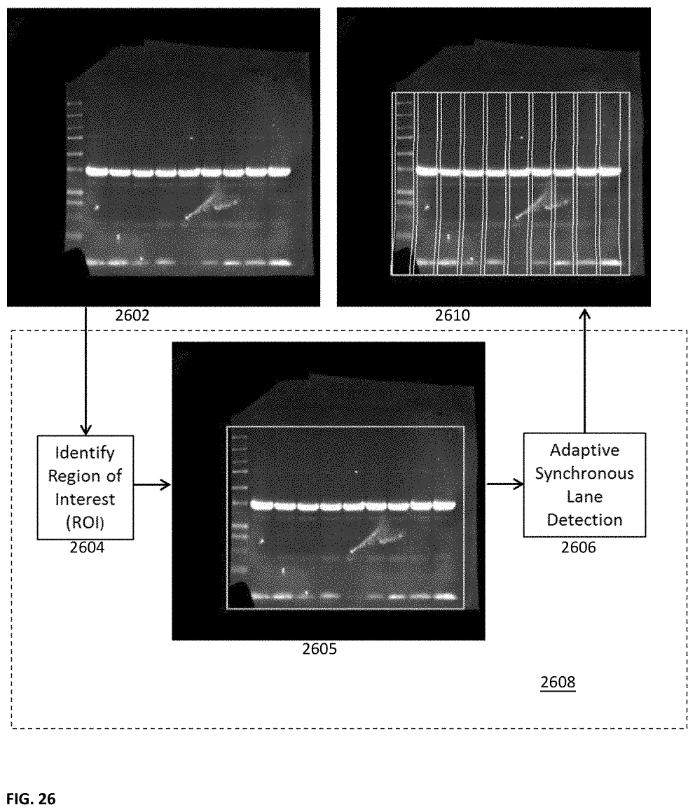

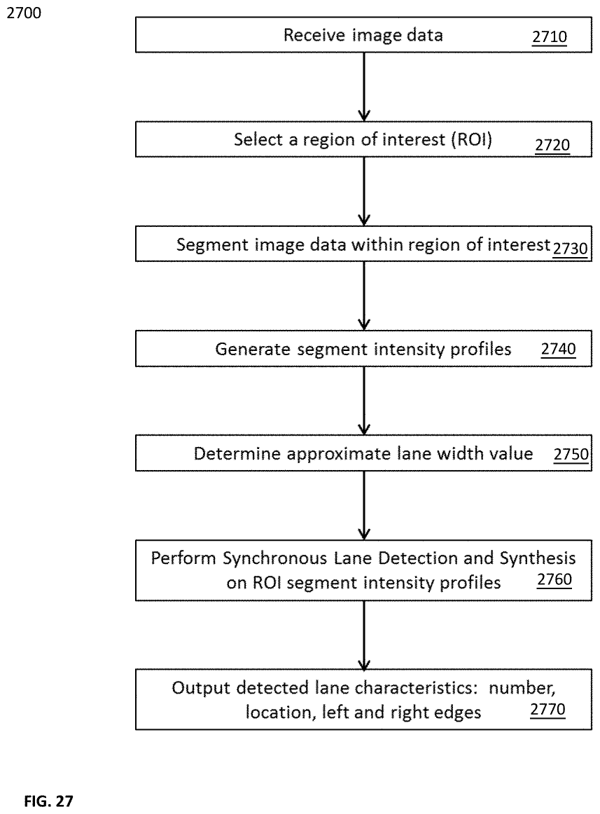

FIG. 26 illustrates a conceptual block diagram of an example system for synchronously detecting lanes on a gel electrophoresis image, according to an embodiment. Accurate quantitative data analysis of a substrate, such as a membrane produced from Western Blot method, is dependent upon the accurate characterization of the lanes' locations. FIG. 27 illustrates a flow diagram of a method 2700 for determining characteristics (e.g., the number, location, orientation, and left and right edges) of the lanes present in electrophoresis image data by synchronous detection and synthesis, according to an embodiment.

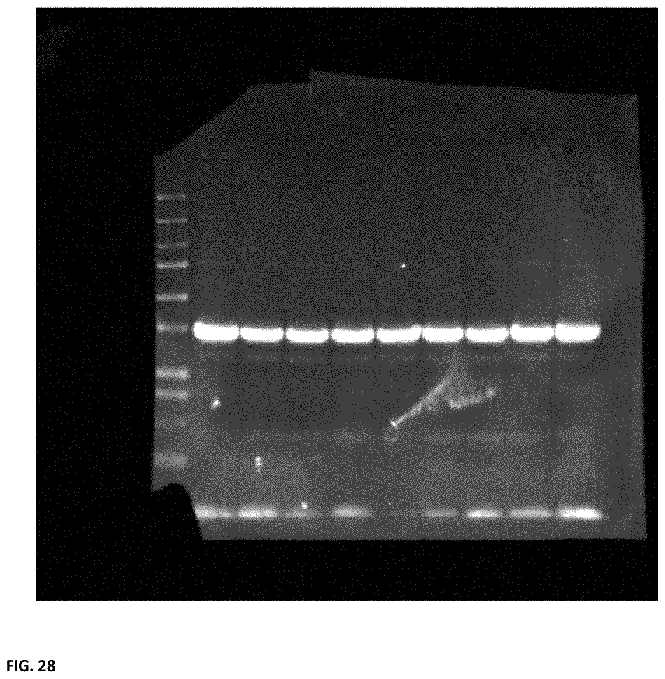

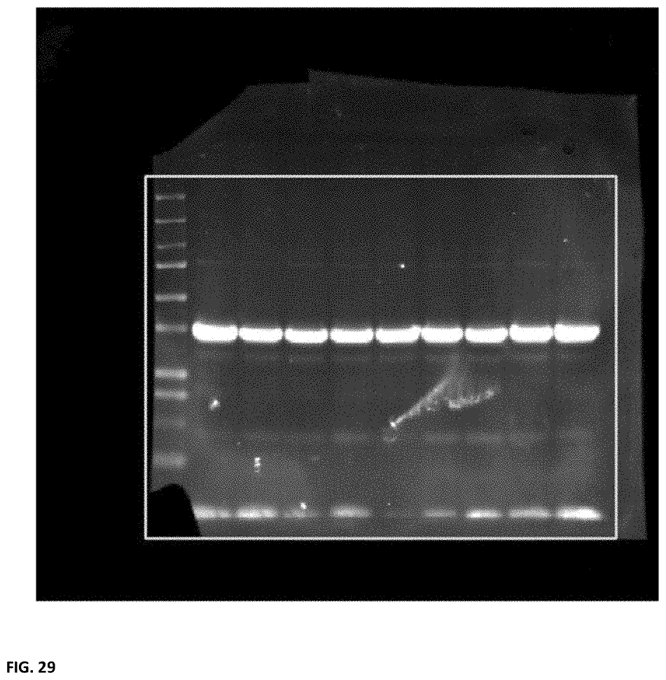

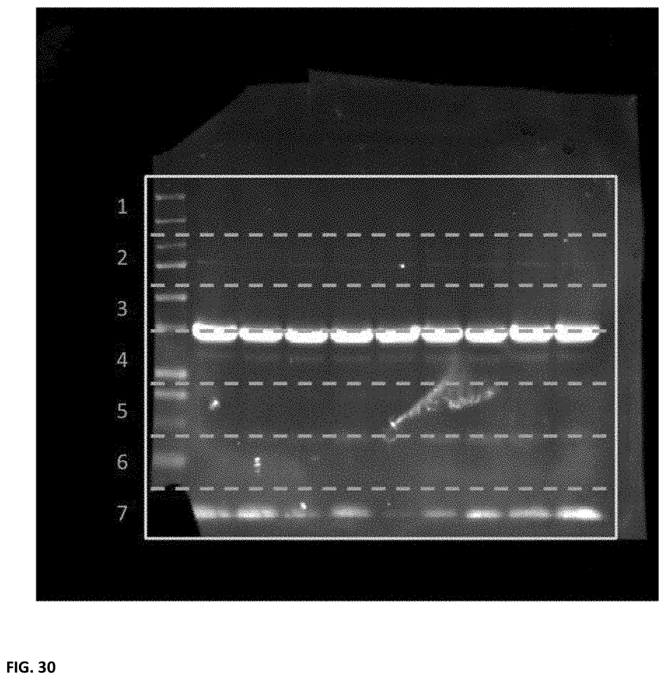

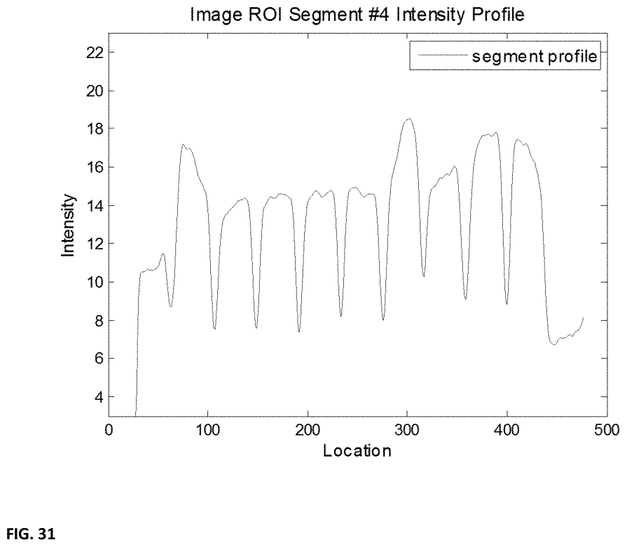

Similar to step 210, the method is initiated at step 2710 by synchronous lane detection and characterization engine 2606 receiving or acquiring an image or image data to be processed, such as an input electrophoresis image data, an example of which is illustrated in FIG. 28. At step 2720, similar to step 220, a region of interest (ROI) is then selected within the image as illustrated in FIG. 29, e.g., by a user or automatically. Similar to step 230, at step 2730, the ROI may be subdivided along the y-axis into several segments as illustrated in FIG. 30, which shows subdivision of the ROI into 7 segments. At step 2740, similar to step 240, segment intensity profiles are generated from each of the subdivided regions or segments by summing along the y-axis (at each x-axis location) within each of the segments. Each segment profile represents the cross-section of the lane intensity along the x-axis for each of the ROI segments. A segment intensity profile for one ROI segment (segment #4) is illustrated in FIG. 31.

Similar to step 250, an approximate lane width value for all the segment profiles is then determined in step 2750. This is an important step in the characterization for each of the individual lanes. A method for determining the approximate lane width value is described in detail above, with reference to FIG. 7 and elsewhere.

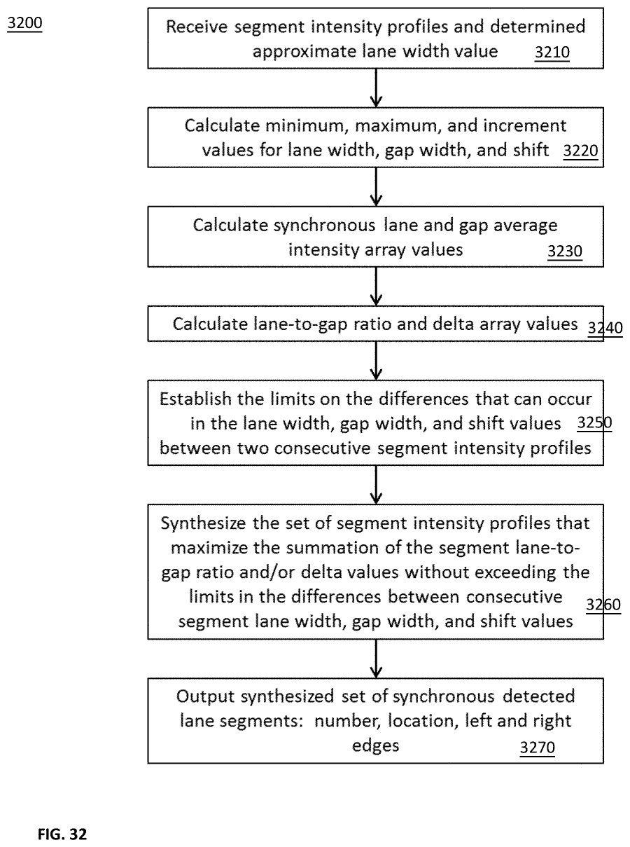

At step 2760, the determined approximate lane width value may then be utilized in a process to synchronously detect and synthesize the lanes from the ROI segment intensity profiles, an example of which is shown in FIG. 32. At step 2770, detected lane characteristics, e.g., number of lanes, location of lanes, left and right edges of lanes, are output for display and/or further processing.

A flow diagram of an example method 3200 for synchronous lane detection and synthesis for the ROI segment intensity profiles is illustrated in FIG. 32. The method 3200 is initiated at step 3210 with synchronous lane detection engine 2606 receiving or acquiring the segment intensity profiles and the determined approximate lane width values. At step 3220, values for lanes and gaps (e.g., locations between lanes) are determined. For example, in an embodiment, minimum, maximum and incremental lane width, gap width, and shift values are determined or calculated. In an embodiment, the minimum, maximum and incremental lane width, gap width, and shift values can be calculated as a percentage of the pre-determined approximate lane width value.

At step 3230, synchronous lane and gap average intensity values are determined. In an embodiment, these values may be collected in or as an array of values. For example, in an embodiment, synchronous lane and gap average intensity array values are calculated in accordance with Equations 6 through 12 as follows:

$$\begin{matrix}{laneAvgInt}_{( i , k , m , n )} = \frac{{laneSumInt}_{( i , k , m , n )}}{{nLanes}_{( k , m , n )} \cdot {lw}_{k}} & ( 6 ) \\ {gapAvgInt}_{( i , k , m , n )} = \frac{{gapSumInt}_{( i , k , m , n )}}{{nGaps}_{( k , m , n )} \cdot {gw}_{m}} & ( 7 ) \\ {laneSumInt}_{( i , k , m , n )} = {\sum }_{p = 0}^{{nLanes}_{( k , m , n )} - 1} ( {\sum }_{j = n + p \cdot {tw}_{k , m )}}^{n - 1 + {lw}_{k} + p \cdot {tw}_{( k , m )}} {y}_{( i , j )} ) & ( 8 )\end{matrix}$$

where:
lwₖ=lane width
gwₘ=gap width
y_{(i,j)}=segment profile data point intensity values
i=1 to M (M=number of segment profiles)
j=1 to N (N=number o f segment profile data points)
k=1 to number of lane widths
m=1 to number of gap widths
n=1 to tw_{(k,m)}
INT=integer (round down)

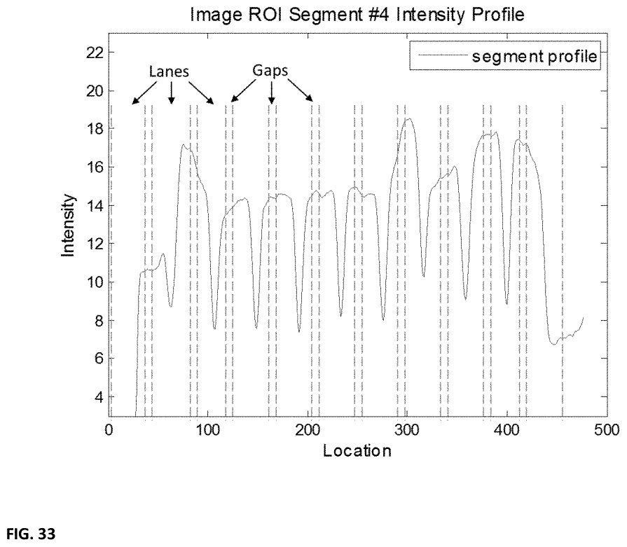

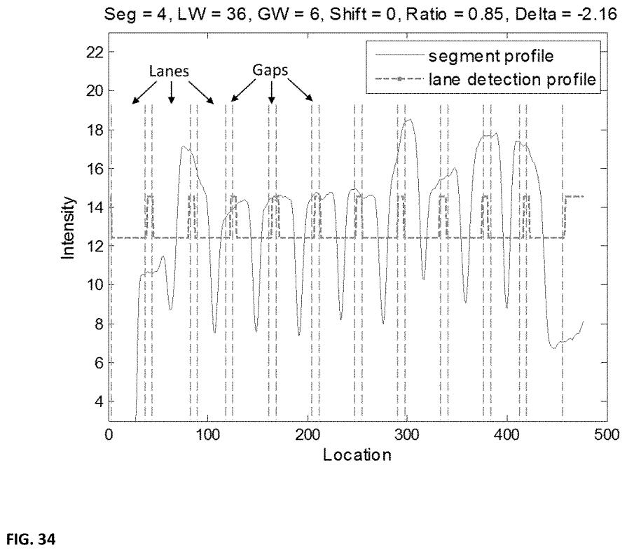

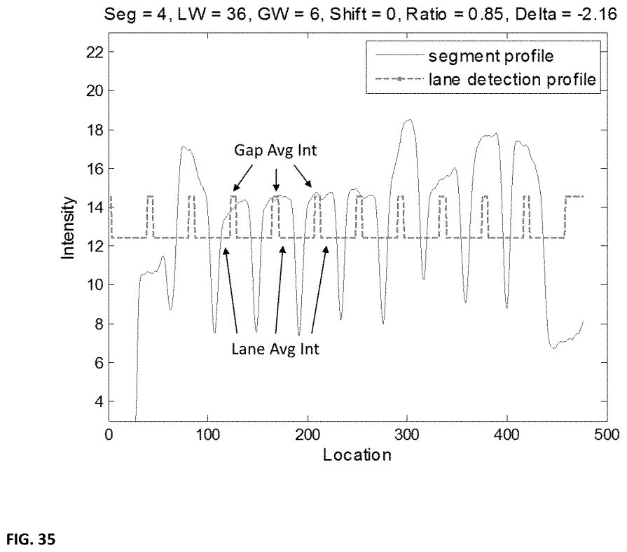

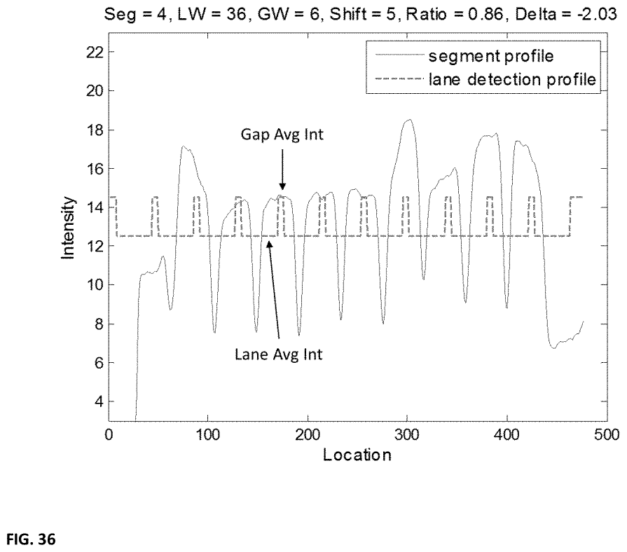

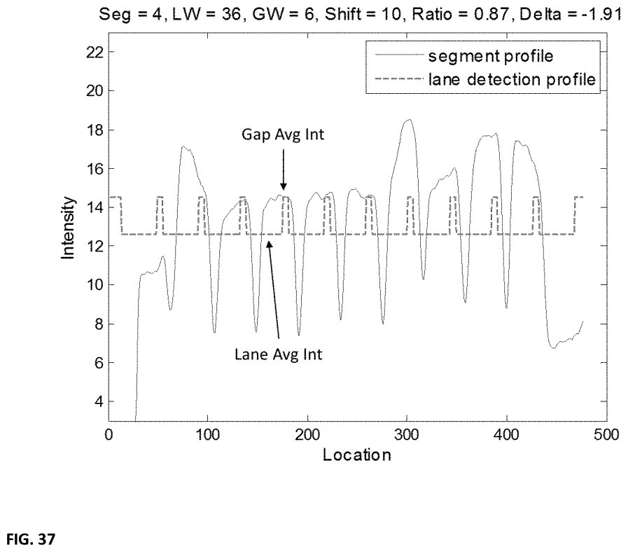

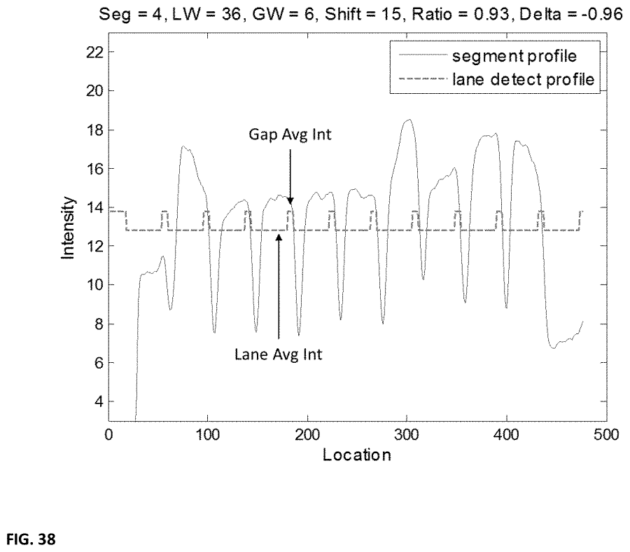

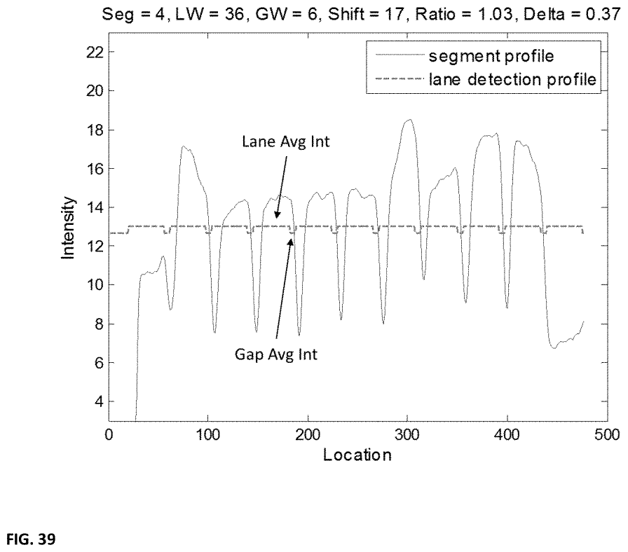

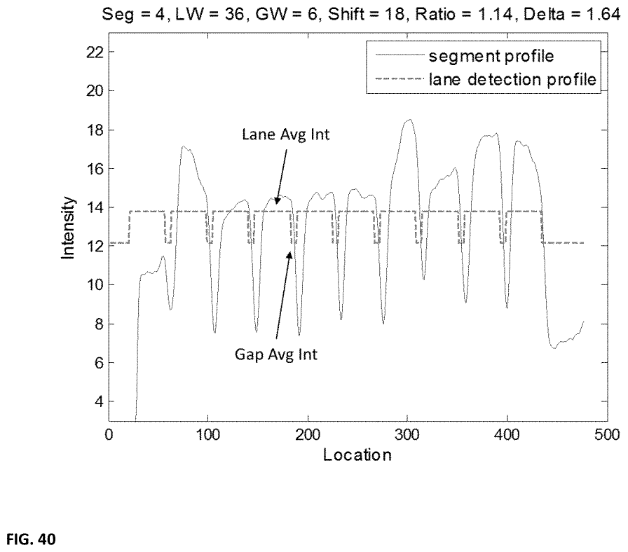

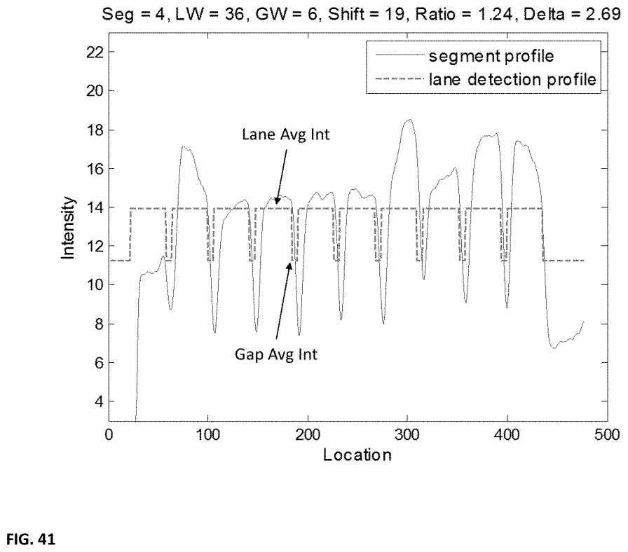

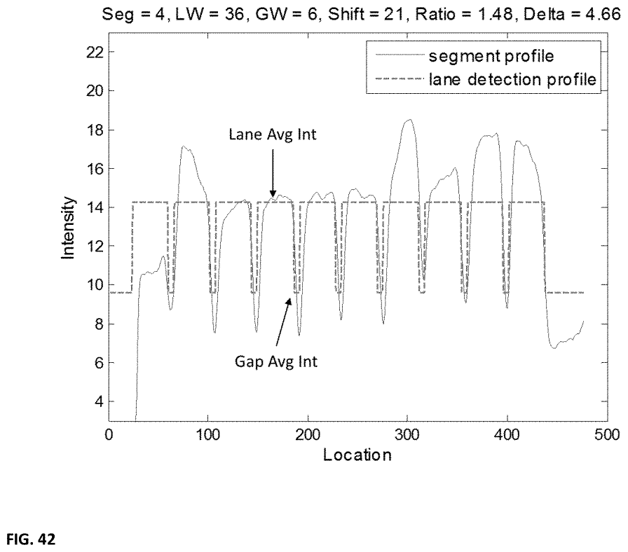

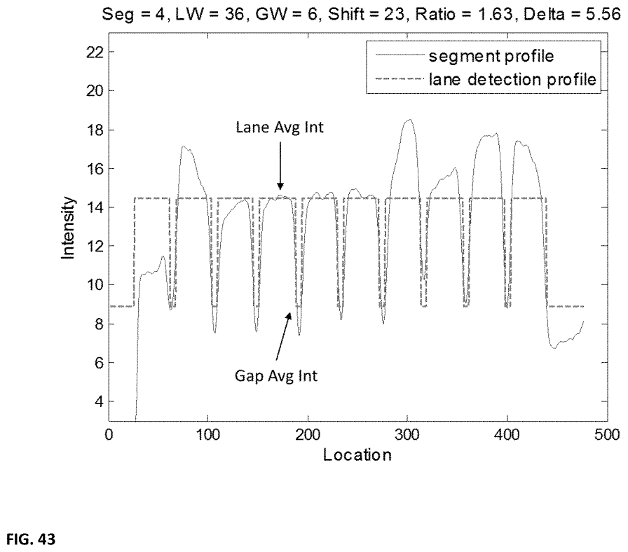

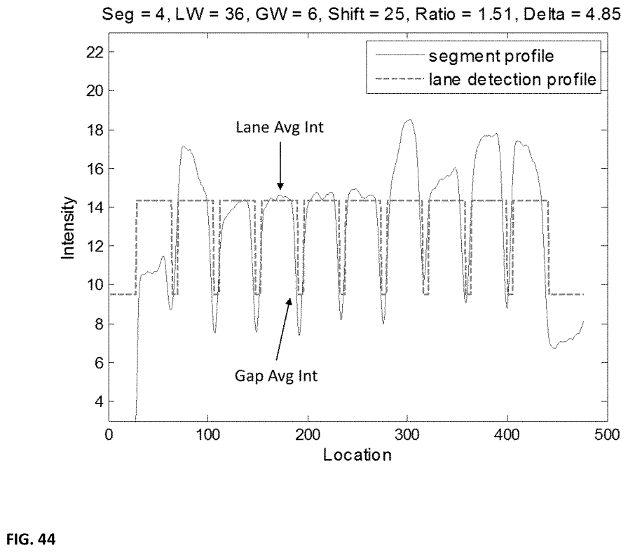

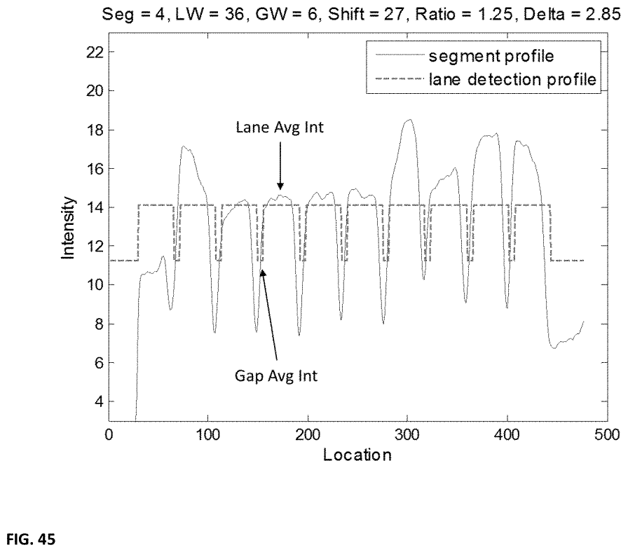

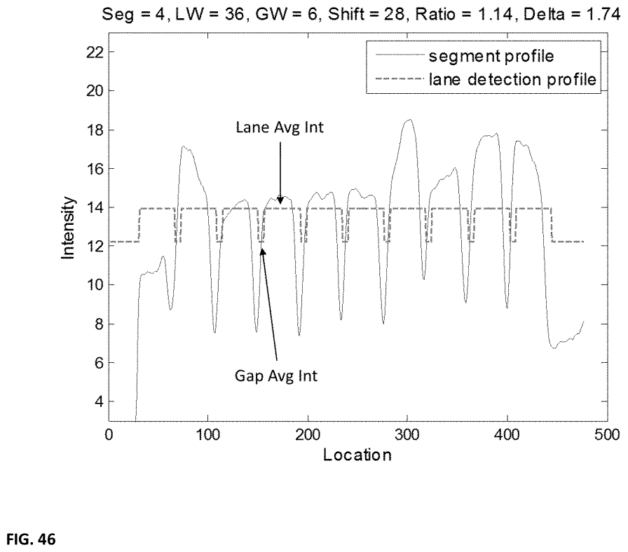

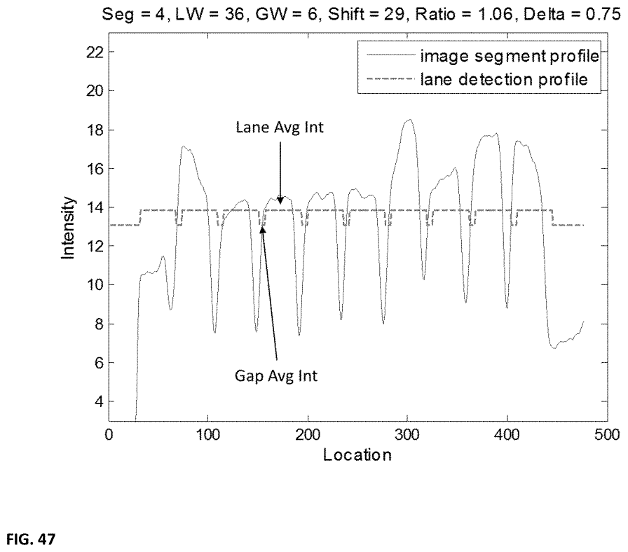

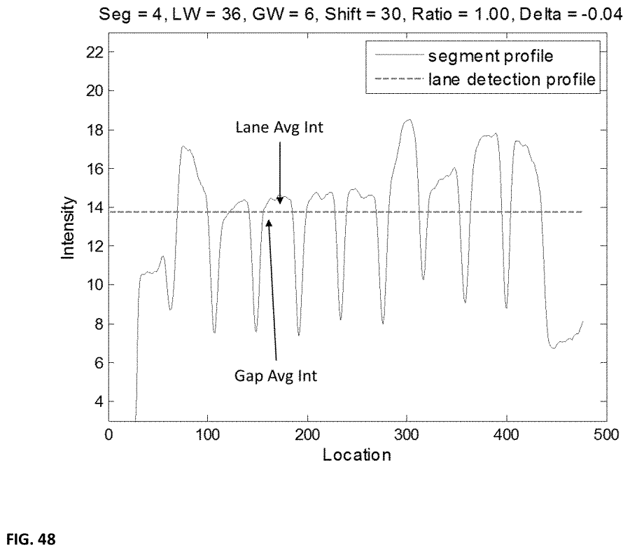

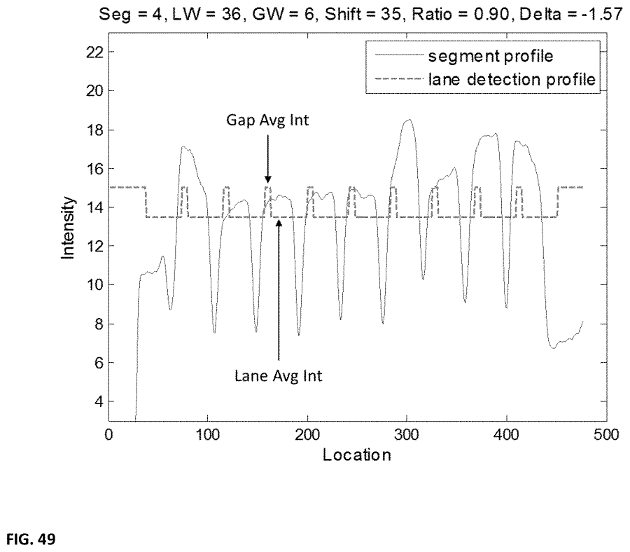

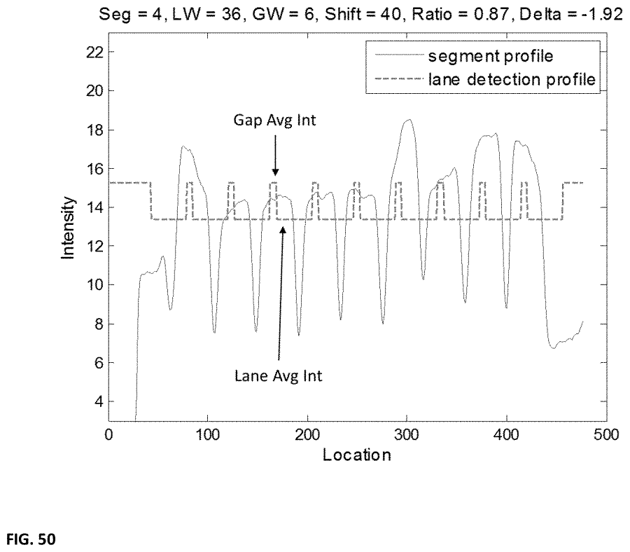

In an embodiment, the lane and gap average intensity values are calculated for all segment profiles and for all combinations of lane width, gap width, and shift values. An example of this calculation for a specified lane width, gap width and shift value of a specified segment intensity profile, as previously shown in FIG. 31, is illustrated in FIGS. 33-35. In an embodiment, the input segment intensity profile (FIG. 31) is sub-divided into the proposed lane and gap boundaries (i.e. the vertical dashed lines) defined by input lane width, gap width, and shift values and is illustrated in FIG. 33. The lane and gap average intensity values are determined by calculating the sum of the profile intensity values within the specified boundaries and then dividing each sum by the total number of data points within their respective boundaries. The average lane and gap intensity values calculated for a specified lane width of 36, gap width of 6 and shift value of 0, are illustrated relative to the input segment intensity profile in FIG. 34 and FIG. 35. Additionally, the average lane and gap intensity values calculated for the equivalent previous lane width and gap width values and incrementally different shift values are illustrated in FIGS. 36-50.

At step 3240, a lane-to-gap ratio value and a delta array value are then calculated from the average lane and gap intensity values. In an embodiment, the lane-to-gap ratio and delta array values are calculated from the average lane and gap intensity values in accordance with Equations 13 and 14 as follows:

$$\begin{matrix}{ratio}_{( i , k , m , n )} = \frac{{laneAvgInt}_{( i , k , m , n )}}{{gapAvgInt}_{( i , k , m , n )}} & ( 13 ) \\ {delta}_{( i , k , m , n )} = {laneAvgInt}_{( i , k , m , n )} - {gapAvgInt}_{( i , k , m , n )} & ( 14 )\end{matrix}$$

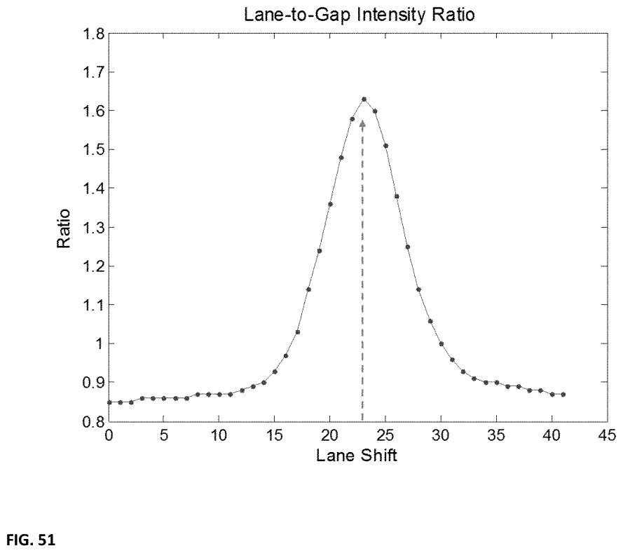

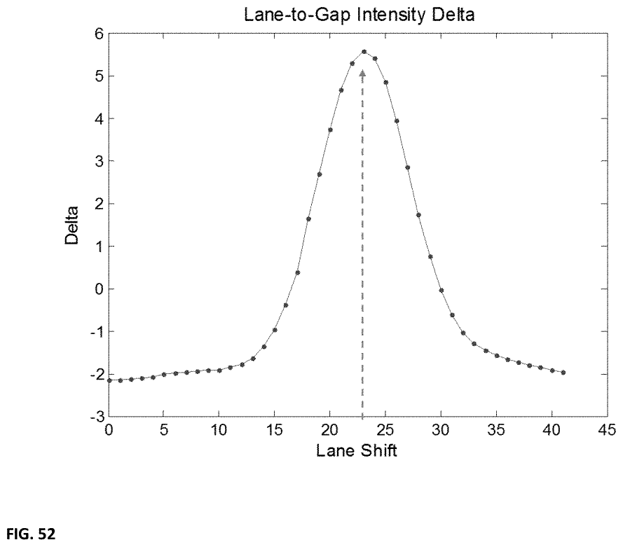

In an embodiment, the lane-to-gap ratio and delta values are calculated for all segment profiles and for all combinations of lane width, gap width, and shift values. The lane-to-gap ratio and delta parameters are important in that the intensity of their values are correlated to the optimal lane width, gap width, and shift values present in the data. For example, the plots in FIG. 51 and FIG. 52 illustrate the changes in the intensity of the lane-to-gap ratio and delta values that can occur as a function of the lane shift value with fixed lane width and gap width values. The higher the intensity of the lane-to-gap ratio and delta values indicates a more optimal location of the lanes relative to the lane width, gap width, and shift values.

At step 3250, the limits on the differences that can occur in the lane width, gap width, and shift values between two consecutive segment intensity profiles are established. These limits can be calculated as a percentage of the approximate lane width value, in an embodiment. At step 3260, a set of successive segment intensity profiles is synthesized or generated such that the maximum summation of the segment lane-to-gap ratio and/or delta values occurs without exceeding the previously established limits in the differences between consecutive segment lane width, gap width, and shift values. In other words, one objective is to obtain the optimal combination of lane widths, gap widths, and shift values for each of the segment intensity profiles within the established limits of each consecutive segment lane parameter, which produces the maximum summation of the sequential segment lane-to-gap ratios and/or deltas.

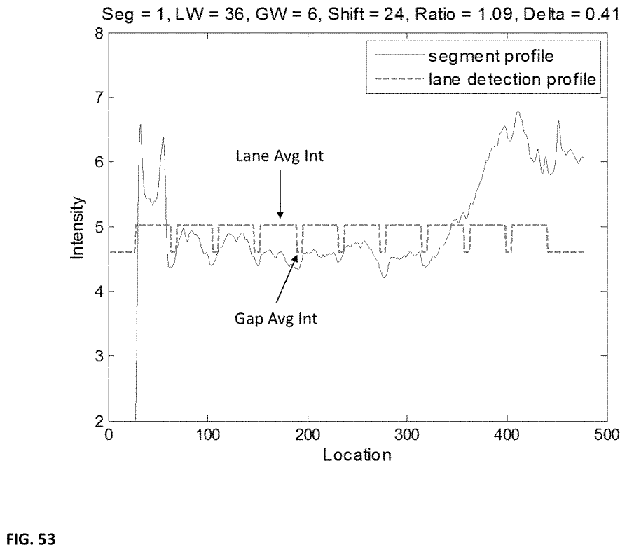

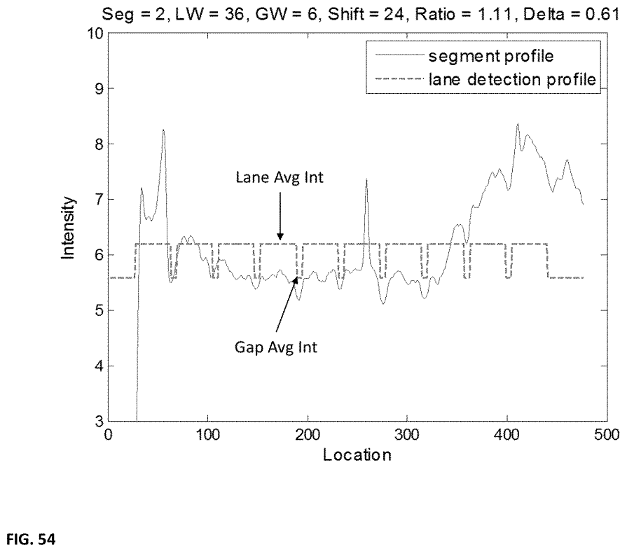

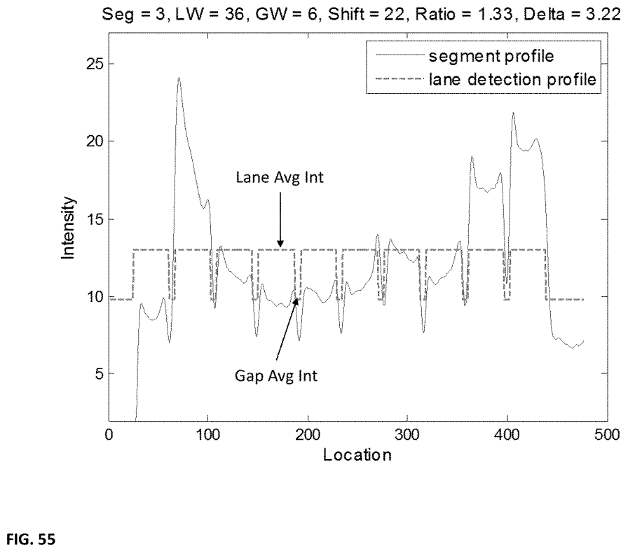

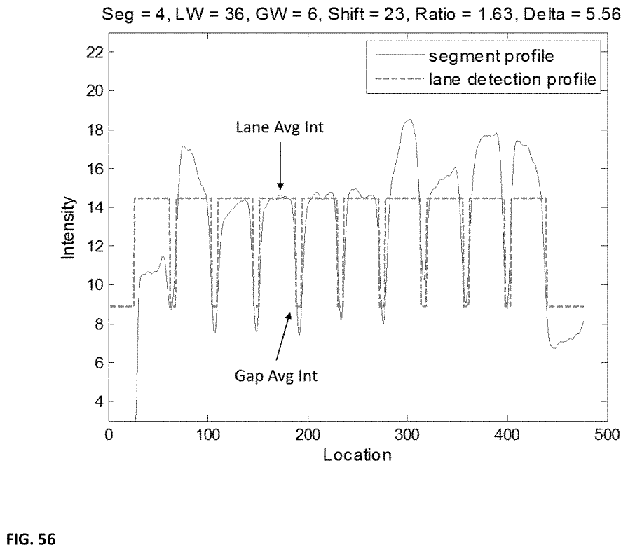

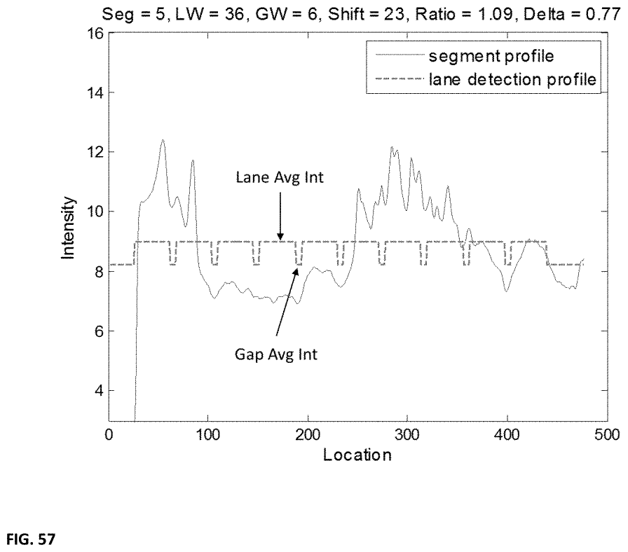

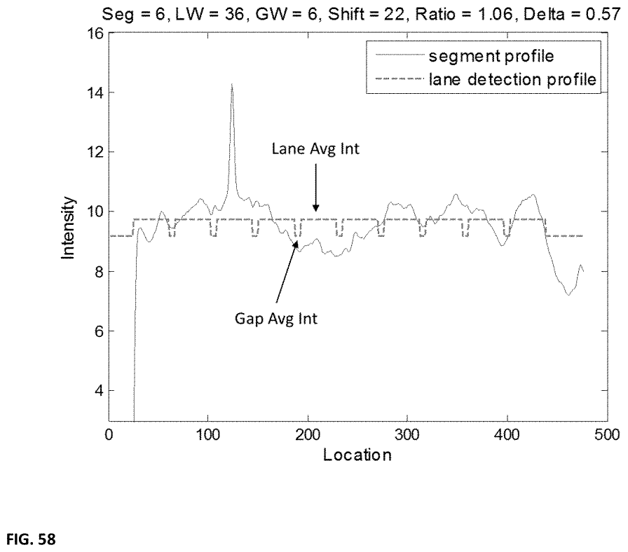

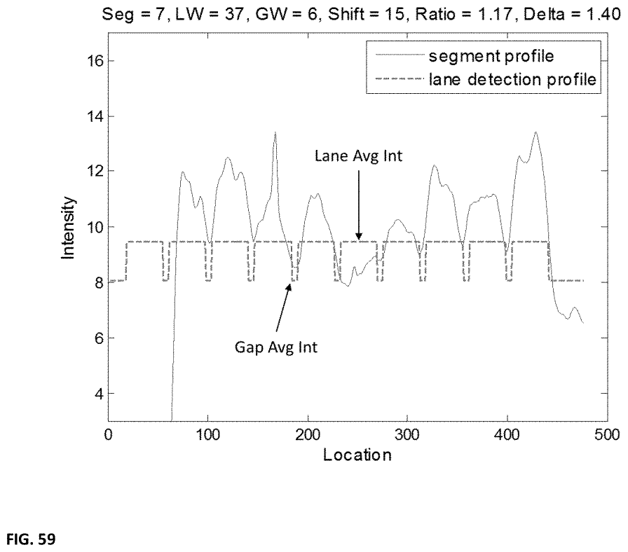

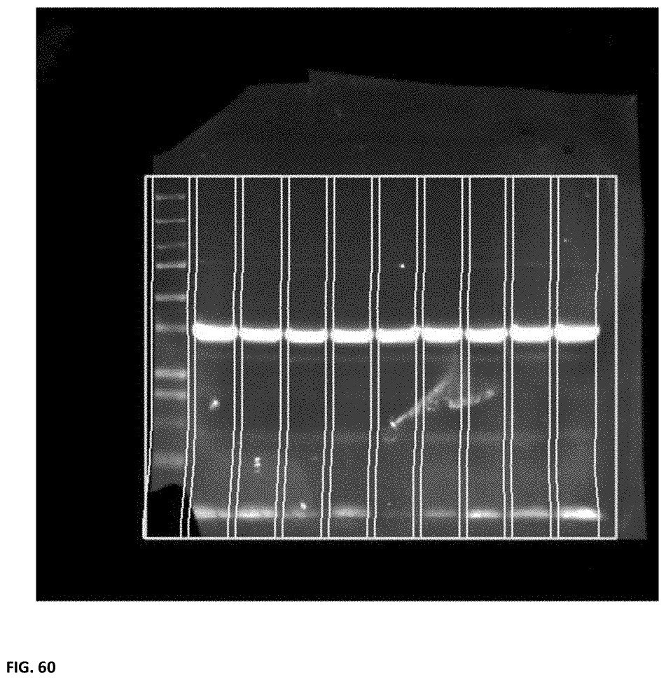

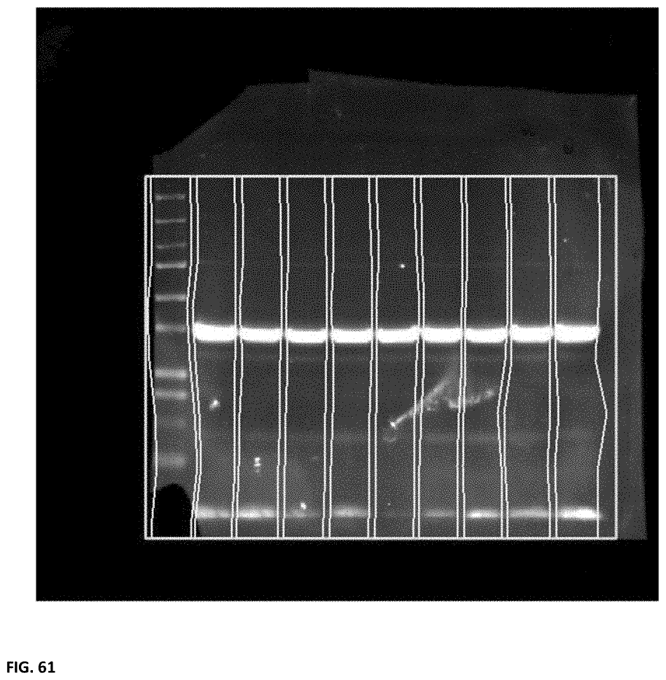

At step 3270, the results of the synthesized set of segment intensity profiles may be output. For example, examples of results of a synthesized set of segment intensity profiles that produced the maximum summation of the segment lane-to-gap ratio and/or delta values within the limits in the differences between consecutive segment lane width, gap width and shift values are illustrated in FIGS. 53-59. These results were derived from the ROI shown in FIG. 29 and associated segment intensity profiles. For example, the results may be displayed as a synchronously detected and synthesized set of lane boundaries on the image from which they were derived as shown in FIG. 60. For comparison purposes, FIG. 61 illustrates the asynchronous (previous) lane detection results. It can be noted the synchronous lane detection results appear to be more accurate than the asynchronous results.

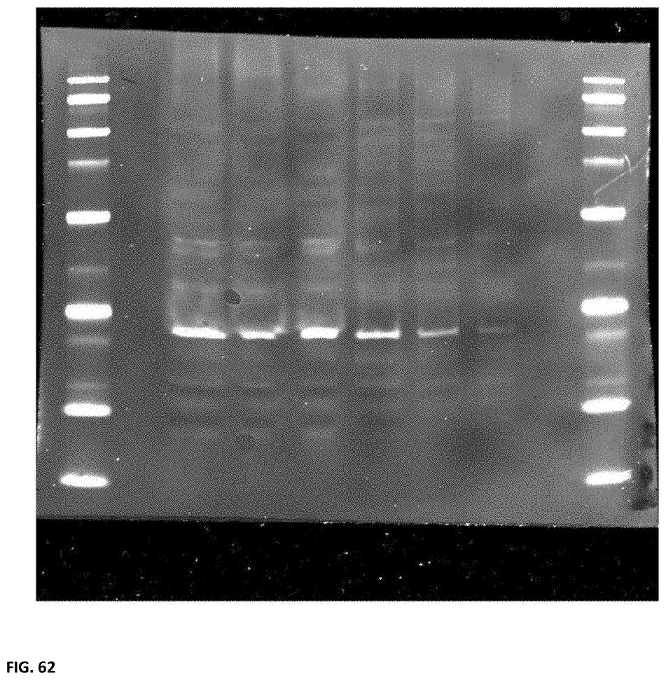

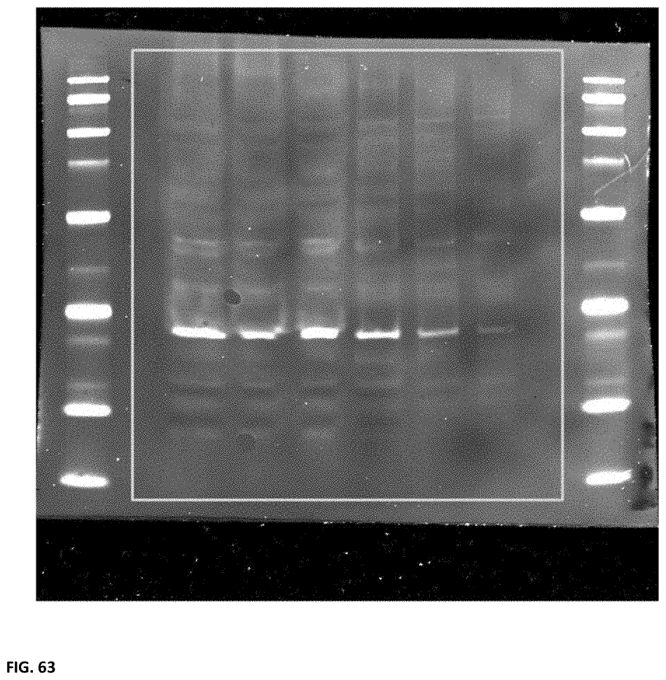

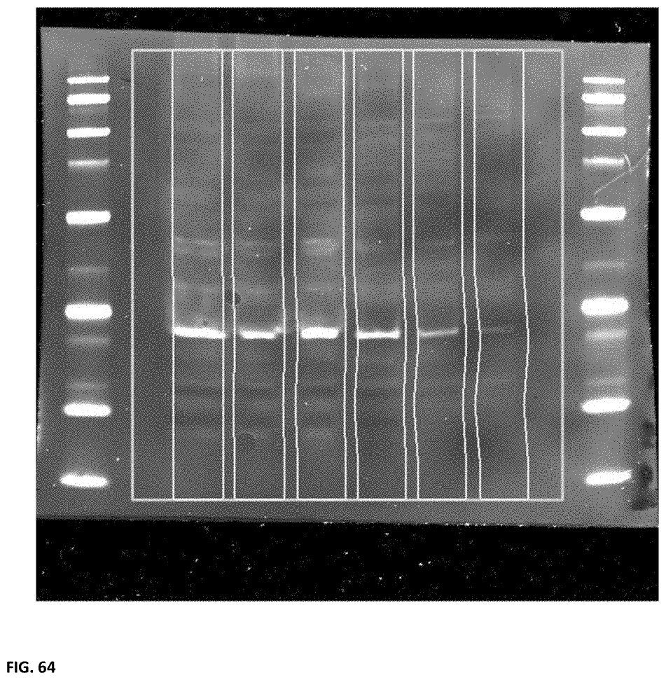

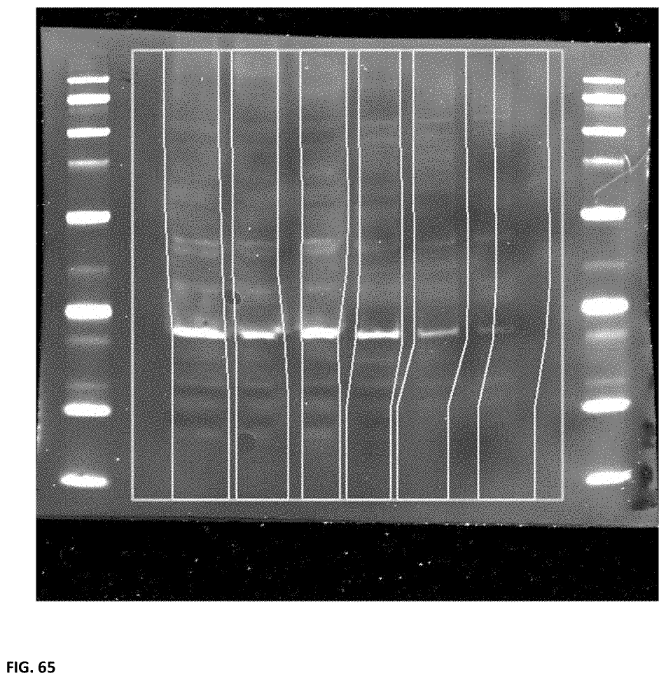

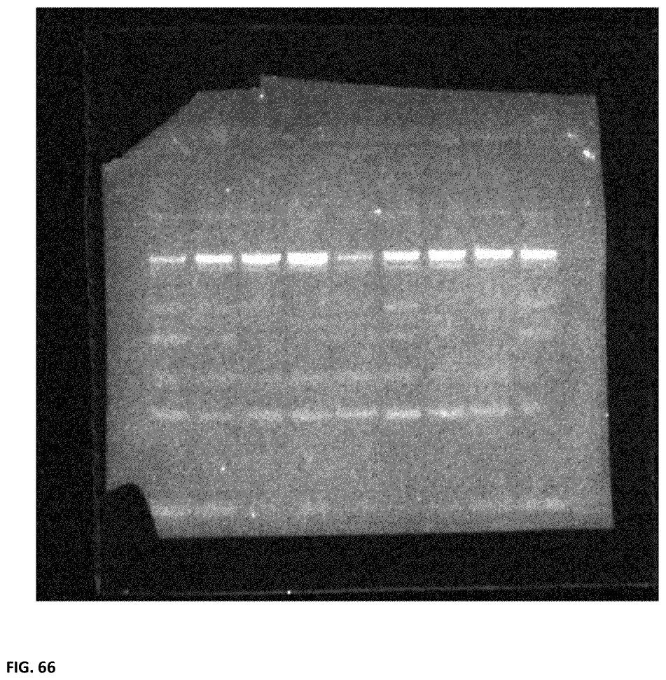

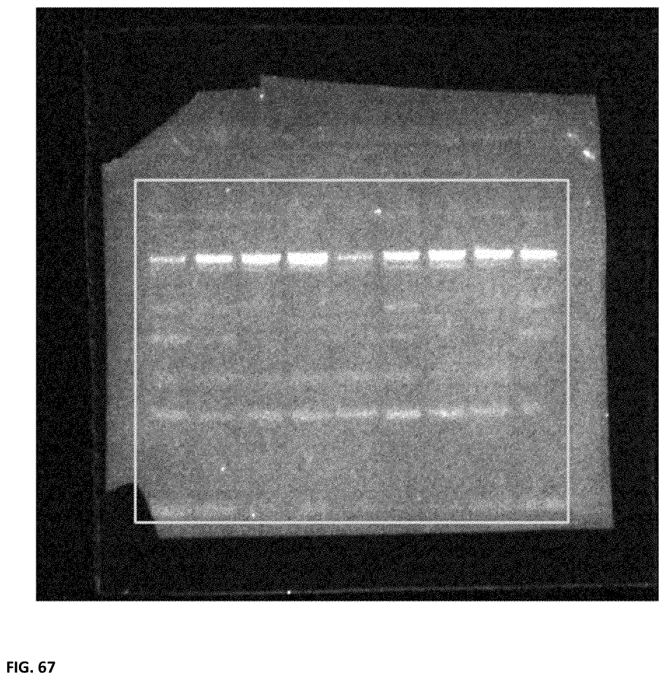

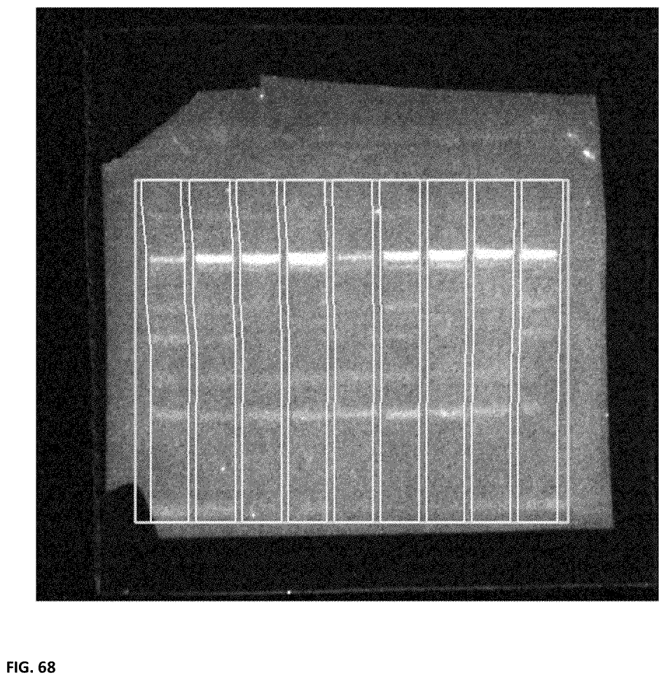

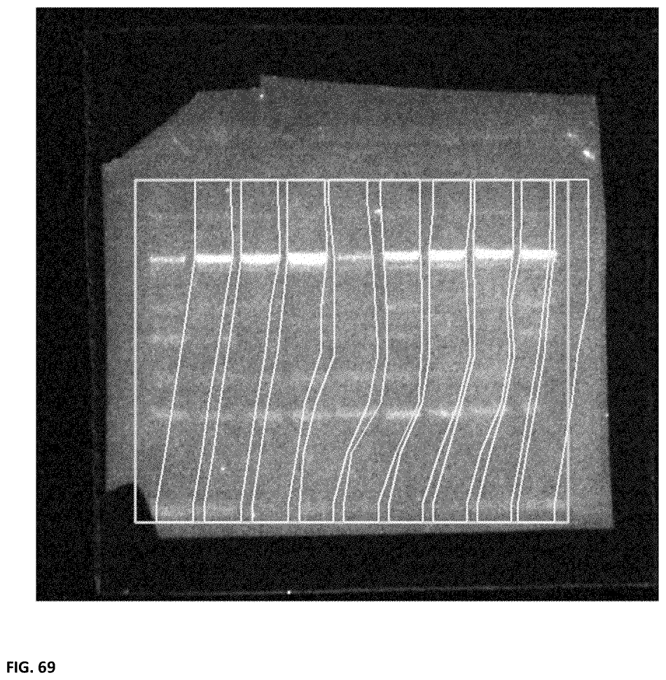

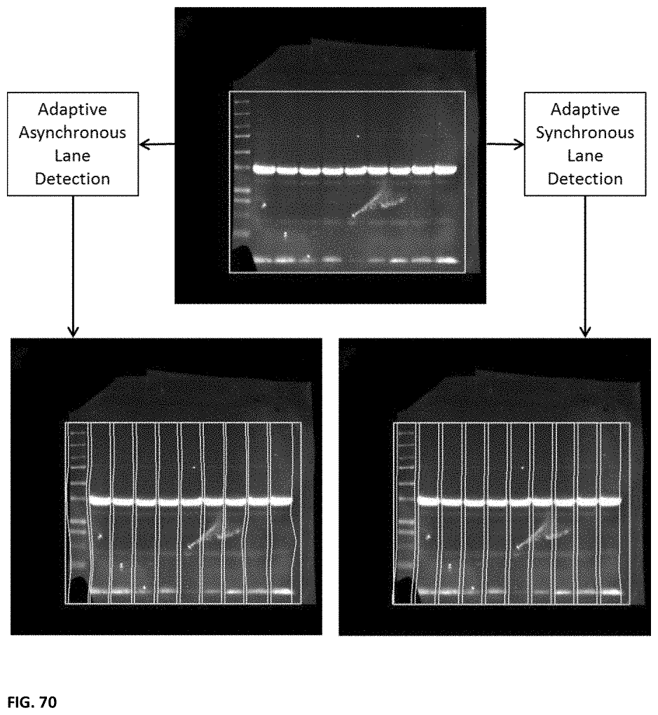

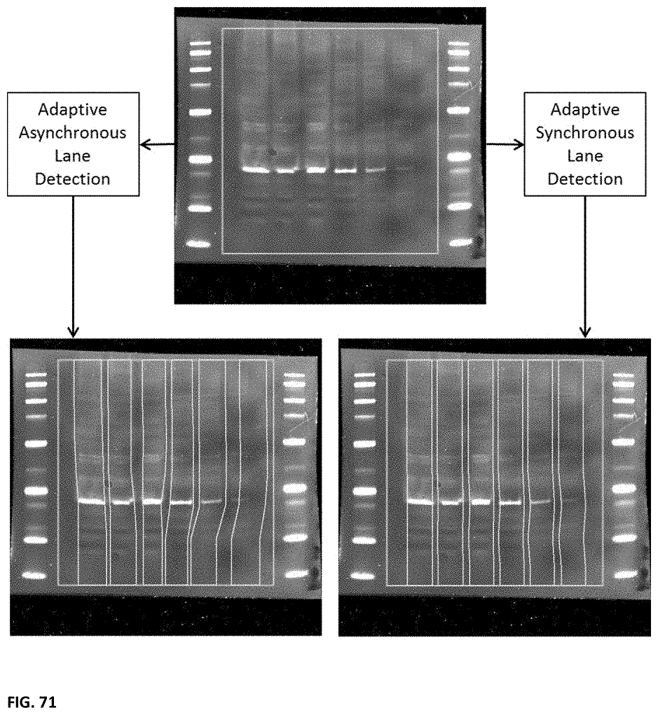

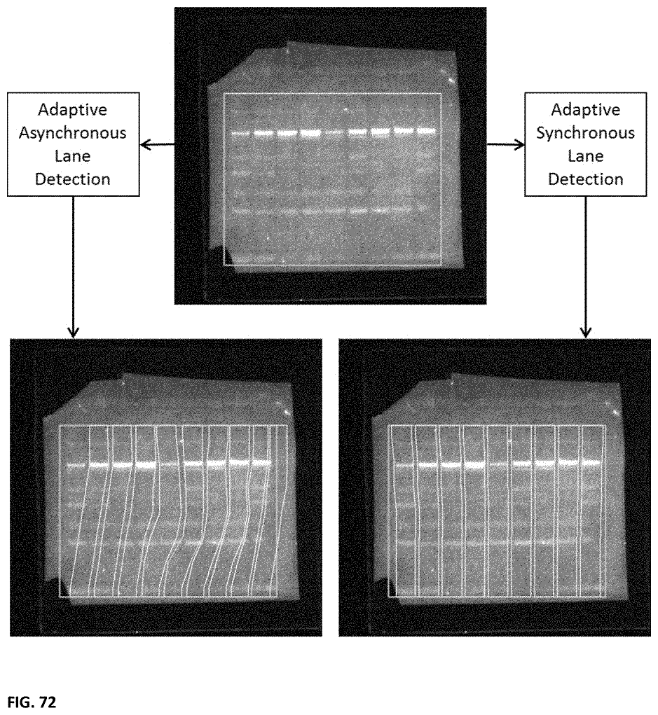

Two additional examples of image data of electrophoresed samples are illustrated in FIG. 62 and FIG. 66. Their respective region of interest is shown in FIG. 63 and FIG. 67, along with the synchronous lane detection results shown in FIG. 64 and FIG. 68. Additionally, for comparison purposes, the asynchronous lane detection results have been provided in FIG. 65 and FIG. 69, respectively. Again, it can be noted the synchronous lane detection results for both images appear to be more accurate than the asynchronous results. Finally, FIG. 70-72 are included to provide a more direct comparison between the asynchronous and synchronous lane detection results.

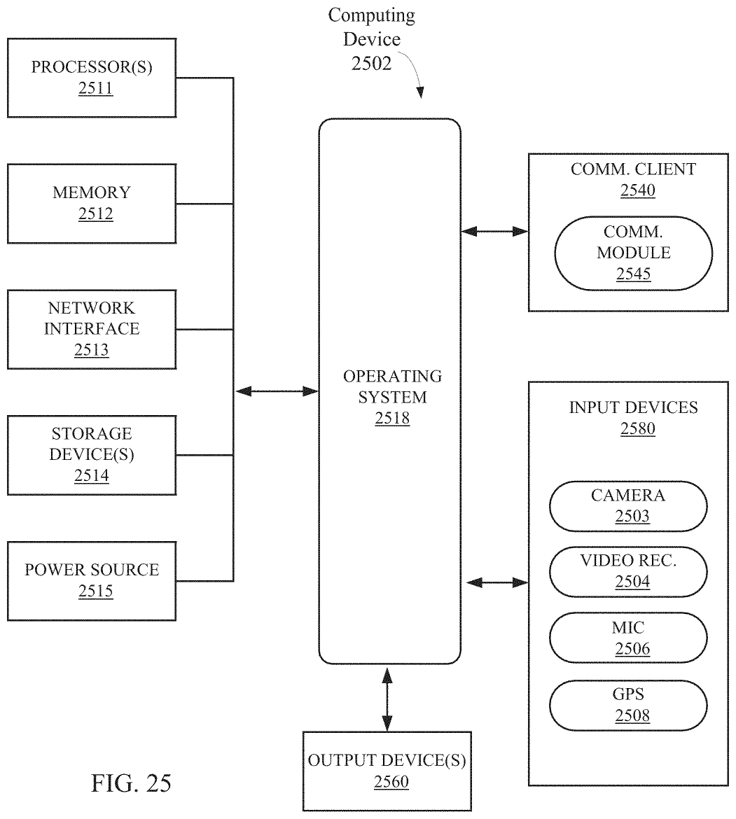

FIG. 25 is a block diagram of example functional components for a computing system or device 2502 configured to perform one or more of the analysis techniques described herein above and/or below, according to an embodiment. One particular example of computing device 2502 is illustrated. Many other embodiments of the computing device 2502 may be used. In the illustrated embodiment of FIG. 25, the computing device 2502 includes one or more processor(s) 2511, memory 2512, a network interface 2513, one or more storage devices 2514, a power source 2515, output device(s) 2560, and input device(s) 2580. The computing device 2502 also includes an operating system 2518 and a communications client 2540 that are executable by the computing device 2502. Each of components 2511, 2512, 2513, 2514, 2515, 2560, 2580, 2518, and 2540 is interconnected physically, communicatively, and/or operatively for inter-component communications in any operative manner.

As illustrated, processor(s) 2511 are configured to implement functionality and/or process instructions for execution within computing device 2502. For example, processor(s) 2511 execute instructions stored in memory 2512 or instructions stored on storage devices 2514. The processor may be implemented as an ASIC including an integrated instruction set. Memory 2512, which may be a non-transient computer-readable storage medium, is configured to store information within computing device 2502 during operation. In some embodiments, memory 2512 includes a temporary memory, area for information not to be maintained when the computing device 2502 is turned OFF. Examples of such temporary memory include volatile memories such as random access memories (RAM), dynamic random access memories (DRAM), and static random access memories (SRAM). Memory 2512 maintains program instructions for execution by the processor(s) 2511. Example programs can include the adaptive lane detection engine 108 in FIG. 1 and the adaptive synchronous lane detection engine 2608 in FIG. 26.

Storage devices 2514 also include one or more non-transient computer-readable storage media. Storage devices 2514 are generally configured to store larger amounts of information than memory 2512. Storage devices 2514 may further be configured for long-term storage of information. In some examples, storage devices 2514 include non-volatile storage elements. Non-limiting examples of non-volatile storage elements include magnetic hard disks, optical discs, floppy discs, flash memories, or forms of electrically programmable memories (EPROM) or electrically erasable and programmable (EEPROM) memories.

The computing device 2502 uses network interface 2513 to communicate with external devices via one or more networks. Network interface 2513 may be a network interface card, such as an Ethernet card, an optical transceiver, a radio frequency transceiver, or any other type of device that can send and receive information. Other non-limiting examples of network interfaces include wireless network interface, Bluetooth®, 9G and WiFi® radios in mobile computing devices, and USB (Universal Serial Bus). In some embodiments, the computing device 2502 uses network interface 2513 to wirelessly communicate with an external device or other networked computing device.

The computing device 2502 includes one or more separate or integrated input devices 2580. Some input devices 2580 are configured to sense the environment and capture images or other signals. Some input devices 2580 are configured to receive input from a user through tactile, audio, video, or other sensing feedback. Non-limiting examples of input devices 2580 include a presence-sensitive screen, a mouse, a keyboard, a voice responsive system, camera 2503, a video recorder 2504, a microphone 2506, a GPS module 2508, or any other type of device for detecting a command from a user or for sensing the environment. In some examples, a presence-sensitive screen includes a touch-sensitive screen.

One or more output devices 2560 are also included in computing device 2502. Output devices 2560 are configured to provide output to another system or device or to a user using tactile, audio, and/or video stimuli. Output devices 2560 may include a display screen (e.g., a separate screen or part of the presence-sensitive screen), a sound card, a video graphics adapter card, or any other type of device for converting a signal into an appropriate form understandable to humans or machines. Additional examples of output device 2560 include a speaker, a cathode ray tube (CRT) monitor, a liquid crystal display (LCD), or any other type of device that can generate intelligible output to a user. In some embodiments, a device may act as both an input device and an output device.

The computing device 2502 includes one or more power sources 2515 to provide power to the computing device 2502. Non-limiting examples of power source 2515 include single-use power sources, rechargeable power sources, and/or power sources developed from nickel-cadmium, lithium-ion, or other suitable material.

The computing device 2502 includes an operating system 2518. The operating system 2518 controls operations of the components of the computing device 2502. For example, the operating system 2518 facilitates the interaction of communications client 2540 with processors 2511, memory 2512, network interface 2513, storage device(s) 2514, input device 2580, output device 2560, and power source 2515.

As also illustrated in FIG. 25, the computing device 2502 includes communications client 2540. Communications client 2540 includes communications module 2545. Each of communications client 2540 and communications module 2545 includes program instructions and/or data that are executable by the computing device 2502. For example, in one embodiment, communications module 2545 includes instructions causing the communications client 2540 executing on the computing device 2502 to perform one or more of the operations and actions described in the present disclosure. In some embodiments, communications client 2540 and/or communications module 2545 form a part of operating system 2518 executing on the computing device 2502.

According to various embodiments, one or more of the components shown in FIG. 25 may be omitted from the computing device 2502.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

Certain embodiments are described herein. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A computer-implemented method of automatically identifying and characterizing one or more lanes in image data for one or more electrophoresed samples, the method comprising:
receiving image data representing an image of one or more lanes of electrophoresed samples;
segmenting the image into one or multiple data segments within a region of interest (ROI) in the image, along a first axis in the ROI, each of the one or multiple data segments traversing one or multiple lanes of the one or more lanes;
generating an intensity profile for each of the one or multiple data segments along a second axis orthogonal to the first axis in the ROI;
determining an approximate lane width value for the one or multiple lanes;
processing, in a synchronous manner, the intensity profile and the approximate lane width value to determine lane characteristics for each of the one or multiple lanes represented in each of the one or multiple data segments, wherein the lane characteristics include a number of the one or multiple lanes, a location of each lane along the second axis, and a left edge and a right edge of each lane along the second axis; and
outputting at least some of the lane characteristics of the one or multiple lanes represented in the one or multiple data segments.

2. The method of claim 1, further including receiving a selection of the ROI, the ROI including data representing the one or multiple lanes.

3. The method of claim 2, wherein the selection of the ROI includes a selection received from a user input device, or a selection received from, or identified by, an artificial intelligence algorithm.

4. The method of claim 1, wherein the processing, in a synchronous manner, the intensity profile and the approximate lane width value to determine lane characteristics for each of the one or multiple lanes represented in the first data segment includes:
calculating minimum and maximum values for each lane width and gap width for the one or multiple lanes represented in each of the one or multiple data segments;
calculating average intensity values for each lane and each gap;
calculating a lane-to-gap ratio and delta values based on the average lane intensity values and average gap intensity values; and
synthesizing a set of intensity profiles for the one or multiple data segments that maximize a summation of the segment lane-to-gap values and/or delta values without exceeding limits on differences that can occur between consecutive lane width and gap width values.

5. The method of claim 1, wherein the determining the approximate lane width value includes:
calculating a derivative of the intensity profile across the second axis to produce a differential curve, the differential curve including positive and negative differential curve pairs;
iteratively producing an array of shifted differential curves by: incrementally shifting the positive and negative differential curve pairs relative to each other by incremental amounts defined by a minimum and a maximum lane width shift parameter value; and combining the positive and negative differential curve pairs together for each lane width shift parameter value to produce a shifted differential curve;
for each of the shifted differential curves in the array: squaring or taking the absolute value and combining the differential curve, and determining a lane width fit error; and
determining a minimum lane width fit error, wherein the lane width shift parameter value corresponding to the minimum lane width fit error is determined as the approximate lane width value.

6. The method of claim 1, further comprising rendering an image of the one or multiple lanes in the first data segment in the ROI, and/or an outline of the one or multiple lanes in the first data segment in the ROI based on the determined locations and parameters of the one or multiple lanes in the first data segment.

7. The method of claim 1, wherein the generating the intensity profile includes summing up intensity values in the first data segment along the second axis for each of a plurality of second axis locations.

8. A system configured to automatically identify and characterize one or more lanes in image data for one or more electrophoresed samples, the system comprising:
one or more processors; and
a memory storing instructions, which when executed by the one or more processors, cause the one or more processors to:
receive image data representing an image of one or more lanes of electrophoresed samples;
segment the image into one or multiple data segments within a region of interest (ROI) in the image, along a first axis in the ROI, each of the one or multiple data segments traversing one or multiple lanes of the one or more lanes;
generate an intensity profile for each of the one or multiple data segments along a second axis orthogonal to the first axis in the ROI;
determine an approximate lane width value for the one or multiple lanes;
process, in a synchronous manner, the intensity profile and the approximate lane width value to determine lane characteristics for each of the one or multiple lanes represented in each of the one or multiple data segments, wherein the lane characteristics include a number of the one or multiple lanes, a location of each lane along the second axis, and a left edge and a right edge of each lane along the second axis; and
output at least some of the lane characteristics of the one or multiple lanes represented in the one or multiple data segments.

9. The system of claim 8, wherein the instructions, which when executed by the one or more processors, further cause the one or more processors to receive a selection of the ROI, the ROI including data representing the one or multiple lanes.

10. The system of claim 9, wherein the selection of the ROI includes a selection received from a user input device, or a selection received from, or identified by, an artificial intelligence algorithm.

11. The system of claim 8, wherein the instructions, which when executed by the one or more processors, cause the one or more processors to process in a synchronous manner, the intensity profile and the approximate lane width value to determine lane characteristics for each of the one or multiple lanes represented in the first data segment include instructions to:
calculate minimum and maximum values for each lane width and gap width for the one or multiple lanes represented in each of the one or multiple data segments;
calculate average intensity values for each lane and each gap;
calculate a lane-to-gap ratio and delta values based on the average lane intensity values and average gap intensity values; and
synthesize a set of intensity profiles for the one or multiple data segments that maximize a summation of the segment lane-to-gap values and/or delta values without exceeding limits on differences that can occur between consecutive lane width and gap width values.

12. The system of claim 8, wherein the instructions, which when executed by the one or more processors, cause the one or more processors to determine the approximate lane width value include instructions to:
calculate a derivative of the intensity profile across the second axis to produce a differential curve, the differential curve including positive and negative differential curve pairs;
iteratively produce an array of shifted differential curves by: incrementally shifting the positive and negative differential curve pairs relative to each other by incremental amounts defined by a minimum and a maximum lane width shift parameter value; and combining the positive and negative differential curve pairs together for each lane width shift parameter value to produce a shifted differential curve;
for each of the shifted differential curves in the array: square or take the absolute value and combine the differential curve, and determine a lane width fit error; and
determine a minimum lane width fit error, wherein the lane width shift parameter value corresponding to the minimum lane width fit error is determined as the approximate lane width value.

13. The system of claim 8, wherein the instructions, which when executed by the one or more processors, further cause the one or more processors to render an image of the one or multiple lanes in the first data segment in the ROI, and/or an outline of the one or multiple lanes in the first data segment in the ROI based on the determined locations and parameters of the one or multiple lanes in the first data segment.

14. The system of claim 8, wherein the instructions, which when executed by the one or more processors, cause the one or more processors to generate the intensity profile include instructions to sum up intensity values in the first data segment along the second axis for each of a plurality of second axis locations.

15. A computer-readable medium storing instructions, which when executed by one or more processors, cause the one or more processors to implement a method of automatically identifying and characterizing one or more lanes in image data for one or more electrophoresed samples, the method comprising:
receiving image data representing an image of one or more lanes of electrophoresed samples;
segmenting the image into one or multiple data segments within a region of interest (ROI) in the image, along a first axis in the ROI, each of the one or multiple data segments traversing one or multiple lanes of the one or more lanes;
generating an intensity profile for each of the one or multiple data segments along a second axis orthogonal to the first axis in the ROI;
determining an approximate lane width value for the one or multiple lanes;
processing, in a synchronous manner, the intensity profile and the approximate lane width value to determine lane characteristics for each of the one or multiple lanes represented in each of the one or multiple data segments, wherein the lane characteristics include a number of the one or multiple lanes, a location of each lane along the second axis, and a left edge and a right edge of each lane along the second axis; and
outputting at least some of the lane characteristics of the one or multiple lanes represented in the one or multiple data segments.

16. The computer-readable medium of claim 15, wherein the method further includes receiving a selection of the ROI, the ROI including data representing the one or multiple lanes.

17. The computer-readable medium of claim 16, wherein the selection of the ROI includes a selection received from a user input device, or a selection received from, or identified by, an artificial intelligence algorithm.

18. The computer-readable medium of claim 15, wherein the processing, in a synchronous manner, the intensity profile and the approximate lane width value to determine lane characteristics for each of the one or multiple lanes represented in the first data segment includes:
calculating minimum and maximum values for each lane width and gap width for the one or multiple lanes represented in each of the one or multiple data segments;
calculating average intensity values for each lane and each gap;
calculating a lane-to-gap ratio and delta values based on the average lane intensity values and average gap intensity values; and
synthesizing a set of intensity profiles for the one or multiple data segments that maximize a summation of the segment lane-to-gap values and/or delta values without exceeding limits on differences that can occur between consecutive lane width and gap width values.

19. The computer-readable medium of claim 15, wherein the determining the approximate lane width value includes:
calculating a derivative of the intensity profile across the second axis to produce a differential curve, the differential curve including positive and negative differential curve pairs;
iteratively producing an array of shifted differential curves by: incrementally shifting the positive and negative differential curve pairs relative to each other by incremental amounts defined by a minimum and a maximum lane width shift parameter value; and combining the positive and negative differential curve pairs together for each lane width shift parameter value to produce a shifted differential curve;
for each of the shifted differential curves in the array: squaring or taking the absolute value and combining the differential curve, and determining a lane width fit error; and
determining a minimum lane width fit error, wherein the lane width shift parameter value corresponding to the minimum lane width fit error is determined as the approximate lane width value.

20. The computer-readable medium of claim 15, wherein the method further includes rendering an image of the one or multiple lanes in the first data segment in the ROI, and/or an outline of the one or multiple lanes in the first data segment in the ROI based on the determined locations and parameters of the one or multiple lanes in the first data segment.
